(19) United States
(12) Patent Application Publication
(10) Pub. No.: US 2026/0038450 A1
(43) Pub. Date: Feb. 5, 2026

(54) DISPAY DEVICE

(71) Applicant: LG Display Co., Ltd., Seoul (KR)

(72) Inventors: Yelim Kil, Seoul (KR); Taejoon Song, Paju-si (KR)

(73) Assignee: LG Display Co., Ltd., Seoul (KR)

(21) Appl. No.: 19/249,086

(22) Filed: Jun. 25, 2025

(30) Foreign Application Priority Data
Jul. 31, 2024 (KR) 10-2024-0101748

(51) Int. Cl. G09G 3/34; G02F 1/1333; G02F 1/1335; G02F 1/13357

(52) U.S. Cl. CPC G09G 3/3413; G02F 1/13338; G02F 1/133603; G02F 1/133607; G02F 1/133612; G02F 1/133621; G09G 2320/0666

(57) ABSTRACT

A display device including a liquid crystal panel including a display area including a first area and a second area at least partially surrounded with the first area, and a non-display area surrounding the display area; a first backlight disposed under the liquid crystal panel and in the first area; a second backlight disposed under the liquid crystal panel and in the second area; and a camera disposed under the liquid crystal panel and adjacent to the second backlight. Further, the second area includes a light incident area vertically overlapping the camera, and a light source is not disposed under the liquid crystal panel in the incident area. The display device also includes a peripheral area surrounding the light incident area, in which the second backlight is disposed under the liquid crystal panel in the peripheral area; and a color filter disposed in an upper direction of the liquid crystal panel in the first area and excluded in the upper direction of the liquid crystal panel in the second area.

### CROSS-REFERENCE TO RELATED APPLICATION

This application claims the benefit under 35 U.S.C. § 119(a) to Korean Patent Application No. 10-2024-0101748, filed on Jul. 31, 2024 in the Korean Intellectual Property Office, all of which are hereby expressly incorporated by reference into the present application.

### BACKGROUND

### Technical Field

The present disclosure relates to a display device, and more particularly, to a display device including a camera disposed under a lower surface of a display panel.

### Discussion of Related Art

The field of display devices for visually displaying electrical information signals is rapidly developing, and research to improve performances such as thinning, lightening, and low power consumption of various display devices continues. Examples of the display devices include a Liquid Crystal Display (LCD), an Electro-Wetting Display (EWD), and an Organic Light Emitting Display (OLED).

The liquid crystal display device (LCD device) displays an image using the optical anisotropy of liquid crystals. In the LCD device, a light source is disposed under the liquid crystal and an electric field is applied to the liquid crystal to control the orientation of the liquid crystals to control the transmittance of light generated from the light source through the liquid crystals to display the image.

In addition, display devices are applied to various mobile devices such as smartphones, tablet PC, and pads, and full-screen display devices that are advantageous in terms of the size and design of mobile devices have been developed. In addition, a multimedia function of a mobile device has recently been improved, and a display device in which an optical electronic device such as a camera or a sensor is embedded in the front surface to increase immersion, or a design including a notch or a punch hole is applied to reduce a space occupied by the camera or the sensor has been developed. However, when the camera or the sensor is disposed in the front surface of the display device, a screen design and screen size can be limited, thereby making it difficult to implement a full-screen display. That is, in a mobile terminal or small display, for example, the camera is located in an upper region under the liquid crystal display. A notched area is also provided to allow for the camera. However, when an image is displayed on the display, the notched area can prevent the image from being sufficiently displayed.

### SUMMARY OF THE DISCLOSURE

In order to solve the above-described problem, the present disclosure provides a display device including a camera in a display area and thus being capable of implementing a full screen display.

One object of the present disclosure is to provide a display device including a light-transmissive area capable of securing a light traveling path to and from a camera in a display area of a display panel.

In addition, another object of the present disclosure is to provide a display device capable of increasing a resolution of a light-transmissive area in a display area of a display panel.

To achieve these and other objects, the present disclosure provides a display device including a liquid crystal panel including a display area including a first area and a second area at least partially surrounded with the first area, and a non-display area surrounding the display area; a first backlight disposed under the liquid crystal panel and in the first area; a second backlight disposed under the liquid crystal panel and in the second area; and a camera disposed under the liquid crystal panel and adjacent to the second backlight. Further, the second area includes a light-transmissive area vertically overlapping the camera, and a light source is not disposed under the liquid crystal panel and in the light-transmissive area A peripheral area surrounds the light-transmissive area. In addition, the second backlight is disposed under the liquid crystal panel and in the peripheral area, a color filter is not disposed on top of the liquid crystal panel and in the second area, and the color filter is disposed on top of the liquid crystal panel and in the first area.

A display device according to implementations of the present disclosure can also include a liquid crystal panel including a display area and a non-display area, wherein the display area includes a first area and a second area having the same length in a column direction in a plan view of the display device, wherein the first area include two portions respectively disposed on both opposing sides in a row direction of the second area; a camera disposed under the liquid crystal panel in a cross sectional view of the display device and disposed in one of both opposing sides in the column of the non-display area ion the plan view, wherein the camera and the second area are aligned with each other in a line in the column direction; a light guide plate disposed under the liquid crystal panel and in the display area; and an LED package module spaced apart from a side surface of the light guide plate and disposed under the liquid crystal panel and in the non-display area, wherein a light receiving element of the camera is oriented to face in a perpendicular direction to a direction in which light from the light guide plate is incident to a light receiving surface of the liquid crystal panel, wherein the LED package module includes: a first backlight oriented to face the side surface of the light guide plate, and configured to emit light of the same color to the light guide plate such that the light of the same color is incident from the light guide plate onto the first area; and a second backlight oriented to face the side surface of the light guide plate and configured to emit light of different colors to the light guide plate such that the light of different colors are incident from the light guide plate onto the second area, wherein a color filter is not disposed on top of the liquid crystal panel and in the second area, and the color filter is disposed on top of the liquid crystal panel and in the first area.

Further, the camera is disposed under the liquid crystal panel, and the backlight including the white LED is disposed under the liquid crystal panel and in a general area of the display area. The additional backlight includes a red LED, a green LED, and a blue LED is disposed under the liquid crystal panel and in the optical area of the display area serving as a light traveling path to and from the camera. Thus, the backlight including the white LED and the additional backlight including a red LED, a green LED, and a blue LED independently operate.

A camera is also disposed to be spaced apart from the side surface the light guide plate disposed under the liquid crystal panel. Further, the backlight including a red LED, a green LED, and a blue LED is disposed on and is spaced from the side surface of the light guide plate such that the backlight including a red LED, a green LED, and a blue LED is aligned with the light traveling path to and from the camera and independently operates.

Thus, the display device according to an embodiment of the present disclosure can display an image in up to the peripheral area around the camera in the display area, thereby implementing a full screen display. Further, the display device can secure the light traveling path to and from the camera through the light-transmissive area from which the color filter is removed and simultaneously increase transmittance of incident light through the light-transmissive area.

In addition, the plurality of areas of the optical sheet can be patterned such that the light beam transmitting through the area closer to the light-transmissive area is refracted in a larger amount so as to be directed toward the light-transmissive area of the optical area. Thus, the image of the pixel can be displayed in an area vertically overlapping the light-transmissive area in which the backlight is not disposed under the lower surface of the liquid crystal panel, and thus the luminance uniformity in the optical area can be increased.

In addition, the camera is disposed under the liquid crystal panel and in the non-display area, the optical prism transmits light from a backlight therethrough to the light-transmissive area and reflects light to be incident on the camera toward the camera, so that a path of light along which the light is incident on the camera and a path of light along which the light from a light source is emitted toward the light receiving surface of the liquid crystal panel are isolated from each other, thereby more effectively increasing luminance uniformity in the optical area.

According to the embodiments of the present disclosure, implementing the full screen display can result in reducing power consumption for light emission. Further, as the power consumption for light emission is reduced, a decrease in lifespan of the display device can be prevented. Also, the power consumption for light emission is reduced, and a decrease in lifespan of the display device is prevented, thereby providing a long-lifespan low-power display device.

Further, as power consumption for light emission is reduced, a decrease in lifespan of the display panel can be mitigated, and quality improvement of the display device can be implemented. As the resolution of the light-transmissive area in the display area is increased, a product quality is improved, thereby reducing a manufacturing cost. In addition, the display device according to the present disclosure can have improved quality by implementing the full screen display, thereby securing product reliability.

Further scope of applicability of the present invention will become apparent from the detailed description given hereinafter. However, the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The present disclosure will become more fully understood from the detailed description given hereinbelow and the accompanying drawings which are given by way of illustration only, and thus are not limitative of the present disclosure.

FIG. 1 is a block diagram schematically illustrating a display device according to an implementation of the present disclosure.

FIG. 2 is a plan view schematically illustrating a liquid crystal panel of a display device according to an implementation of the present disclosure.

FIG. 3A is a cross-sectional view taken along a line I-I′ of FIG. 2, and is a cross-sectional view schematically illustrating a display device according to an implementation of the present disclosure.

FIG. 3B is an enlarged view of a portion A of FIG. 3A.

FIG. 4 is a cross-sectional view schematically illustrating a general area of a liquid crystal panel according to an implementation of the present disclosure.

FIG. 5 is a cross-sectional view schematically illustrating an optical area of a liquid crystal panel according to an implementation of the present disclosure.

FIG. 6 is a cross-sectional view illustrating an arrangement structure of color filters included in the liquid crystal panel shown in FIG. 3A.

FIG. 7 is a timing diagram for illustrating an example of a backlight driving scheme in a camera-off state of a display device according to an implementation of the present disclosure.

FIG. 8 is a timing diagram for illustrating an example of a backlight driving scheme in a camera-on state of a display device according to an implementation of the present disclosure.

FIG. 9 is a timing diagram for illustrating another example of a backlight driving scheme in a camera-on state of a display device according to an implementation of the present disclosure.

FIG. 10 is a plan view schematically illustrating a liquid crystal panel of a display device according to another implementation of the present disclosure.

FIG. 11 is a cross-sectional view taken along a line II-Il′ of FIG. 10, and is a cross-sectional view schematically illustrating a display device according to another implementation of the present disclosure.

FIG. 12 is a plan view schematically illustrating a display device according to still another implementation of the present disclosure.

FIG. 13 is an exploded perspective view illustrating a display device according to still another implementation of the present disclosure.

FIG. 14 is a coupled cross-sectional view illustrating a portion of a display device according to still another implementation of the present disclosure.

FIG. 15 is an enlarged perspective view of an LED package module according to still another implementation of the present disclosure.

FIG. 16 is a diagram for illustrating a beam angle of an LED package according to still another implementation of the present disclosure.

FIG. 17 is a plan view illustrating an operation in each area of a liquid crystal panel according to still another implementation of the present disclosure.

FIG. 18 is a timing diagram for illustrating a driving scheme on each area of a liquid crystal panel according to still another implementation of the present disclosure.

FIG. 19 is a diagram for illustrating a backlight operation in a camera off state of a display device according to still another implementation of the present disclosure.

FIG. 20 is a diagram for illustrating a backlight operation in a camera on state of a display device according to still another implementation of the present disclosure.

FIG. 21 is a timing diagram for illustrating a backlight operation in a camera on state of a display device according to still another implementation of the present disclosure.

### DETAILED DESCRIPTIONS

Advantages and features of the present disclosure, and a method of achieving the advantages and features will become apparent with reference to implementations described below in detail together with the accompanying drawings. However, the present disclosure is not limited to the implementations as disclosed under, but can be implemented in various different forms. Thus, these implementations are set forth only to make the present disclosure complete, and to entirely inform the scope of the present disclosure to those of ordinary skill in the technical field to which the present disclosure belongs, and the present disclosure is only defined by the scope of the claims.

For simplicity and clarity of illustration, elements in the drawings are not necessarily drawn to scale. The same reference numbers in different drawings represent the same or similar elements, and as such perform similar functionality. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure can be practiced without these specific details. In other instances, well-known methods, procedures, components, and circuits have not been described in detail so as not to unnecessarily obscure aspects of the present disclosure. Examples of various implementations are illustrated and described further below. It will be understood that the description herein is not intended to limit the claims to the specific implementations described. On the contrary, it is intended to cover alternatives, modifications, and equivalents as can be included within the spirit and scope of the present disclosure as defined by the appended claims.

A shape, a size, a ratio, an angle, a number, etc. disclosed in the drawings for illustrating implementations of the present disclosure are illustrative, and the present disclosure is not limited thereto. The terminology used herein is directed to the purpose of describing particular implementations only and is not intended to be limiting of the present disclosure. As used herein, the singular constitutes “a” and “an” are intended to include the plural constitutes as well, unless the context clearly indicates otherwise. It will be further understood that the terms “comprise”, “comprising”, “include”, and “including” when used in this disclosure, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of associated listed items. Expression such as “at least one of” when preceding a list of elements can modify the entire list of elements and may not modify the individual elements of the list.

In interpretation of numerical values, an error or tolerance therein can occur even when there is no explicit description thereof. In addition, it will also be understood that when a first element or layer is referred to as being present “on” a second element or layer, the first element can be disposed directly on the second element or can be disposed indirectly on the second element with a third element or layer being disposed between the first and second elements or layers.

It will be understood that when a first element or layer is referred to as being “connected to”, or “coupled to” a second element or layer, the first element can be directly connected to or coupled to the second element or layer, or one or more intervening elements or layers can be present therebetween. In addition, it will also be understood that when an element or layer is referred to as being “between” two elements or layers, it can be the only element or layer between the two elements or layers, or one or more intervening elements or layers can also be present therebetween.

Further, as used herein, when a layer, film, area, plate, or the like is disposed “on” or “on top” of another layer, film, area, plate, or the like, the former can directly contact the latter or still another layer, film, area, plate, or the like can be disposed between the former and the latter. As used herein, when a layer, film, area, plate, or the like is directly disposed “on” or “on top” of another layer, film, area, plate, or the like, the former directly contacts the latter and still another layer, film, area, plate, or the like is not disposed between the former and the latter. Further, as used herein, when a layer, film, area, plate, or the like is disposed “beneath” or “under” another layer, film, area, plate, or the like, the former can directly contact the latter or still another layer, film, area, plate, or the like can be disposed between the former and the latter. As used herein, when a layer, film, area, plate, or the like is directly disposed “below” or “under” another layer, film, area, plate, or the like, the former directly contacts the latter and still another layer, film, area, plate, or the like is not disposed between the former and the latter.

In descriptions of temporal relationships, for example, temporal precedent relationships between two events such as “after”, “subsequent to”, “before”, etc., another event can occur therebetween unless “directly after”, “directly subsequent” or “directly before” is not indicated. When a certain implementation can be implemented differently, a function or an operation specified in a specific block can occur in a different order from an order specified in a flowchart. For example, two blocks in succession can be actually performed substantially concurrently, or the two blocks can be performed in a reverse order depending on a function or operation involved.

It will be understood that, although the terms “first”, “second”, “third”, and so on can be used herein to describe various elements, components, areas, layers and/or periods, these elements, components, areas, layers and/or periods should not be limited by these terms. These terms are used to distinguish one element, component, area, layer or section from another element, component, area, layer or section. Thus, a first element, component, area, layer or section as described under could be termed a second element, component, area, layer or section, without departing from the spirit and scope of the present disclosure.

When an implementation can be implemented differently, functions or operations specified within a specific block can be performed in a different order from an order specified in a flowchart. For example, two consecutive blocks can actually be performed substantially simultaneously, or the blocks can be performed in a reverse order depending on related functions or operations.

The features of the various implementations of the present disclosure can be partially or entirely combined with each other, and can be technically associated with each other or operate with each other. The implementations can be implemented independently of each other and can be implemented together in an association relationship.

In interpreting a numerical value, the value is interpreted as including an error range unless there is no separate explicit description thereof. Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, “implementations,” “examples,” “aspects, etc. should not be construed such that any aspect or design as described is superior to or advantageous over other aspects or designs. Further, the term ‘or’ means ‘inclusive or’ rather than ‘exclusive or’. That is, unless otherwise stated or clear from the context, the expression that ‘x uses a or b’ means one of natural inclusive permutations.

The terms used in the description as set forth below have been selected as being general and universal in the related technical field. However, there can be other terms than the terms depending on the development and/or change of technology, convention, preference of technicians, etc. Therefore, the terms used in the description as set forth below should not be understood as limiting technical ideas, but should be understood as examples of the terms for illustrating implementations. Further, in a specific case, a term can be arbitrarily selected by the applicant, and in this case, the detailed meaning thereof will be described in a corresponding description period. Therefore, the terms used in the description as set forth below should be understood based on not simply the name of the terms, but the meaning of the terms and the contents throughout the Detailed Descriptions.

In description of flow of a signal, for example, when a signal is delivered from a node A to a node B, this can include a case where the signal is transferred from the node A to the node B via another node unless a phrase ‘immediately transferred’ or ‘directly transferred’ is used. Throughout the present disclosure, “A and/or B” means A, B, or A and B, unless otherwise specified, and “C to D” means C inclusive to D inclusive unless otherwise specified.

As used herein, a first direction, a second direction, and a third direction, or an X-axis direction, a Y-axis direction, and a Z-axis direction should not be interpreted only as having a geometric relationship with each other in which the first direction, the second direction, and the third direction are perpendicular to each other or the X-axis direction, the Y-axis direction, and the Z-axis direction are perpendicular to each other, but can be interpreted as having a geometric relationship with each other in which the first direction, the second direction, and the third direction interest each other at an angle other than 90 degrees or the X-axis direction, the Y-axis direction, and the Z-axis direction are interest each other at an angle other than 90 degrees within a range in which a configuration of the present disclosure can work functionally.

When a first component or layer is described as “contacting” or “overlapping” a second component or layer, it should be understood that the first component or layer can directly contact or overlap the second component or layer, or a third component or layer can be interposed between the first and second components or layers that can indirectly contact or overlap each other unless otherwise specified.

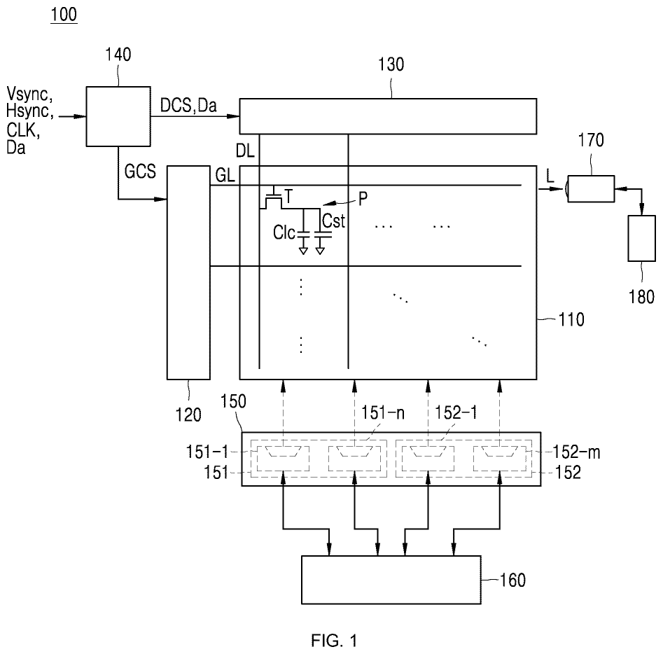

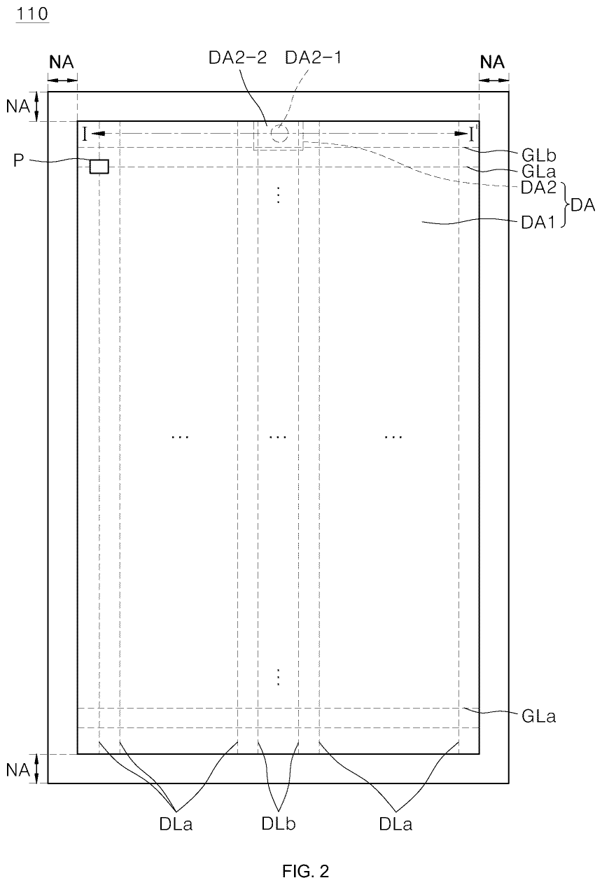

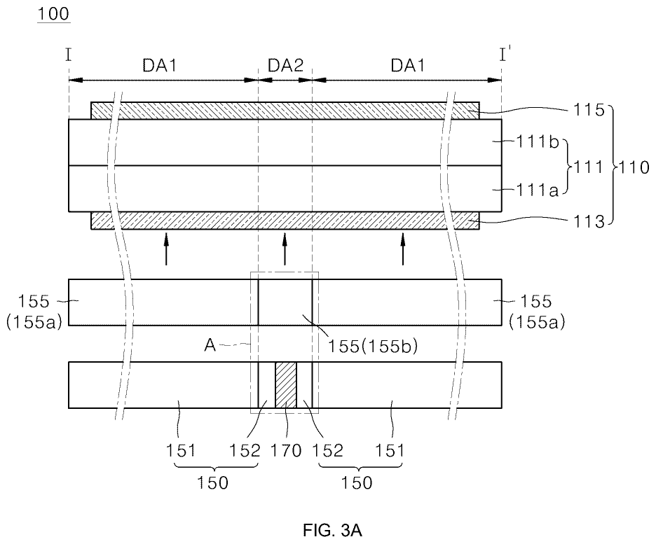

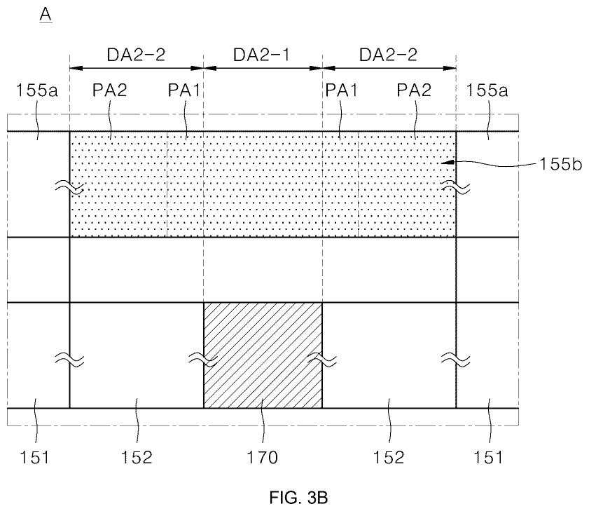

Hereinafter, various implementations of the present disclosure will be described in detail with reference to the accompanying drawings. In particular, FIG. 1 is a block diagram schematically illustrating a display device 100 and FIG. 2 is a plan view schematically illustrating a liquid crystal panel 110 of a display device 100 according to an implementation of the present disclosure. In addition, FIG. 3A is a cross-sectional view taken along a line I-I′ of FIG. 2, and is a cross-sectional view schematically illustrating a display device according to an implementation of the present disclosure. FIG. 3B is an enlarged view of a portion A of FIG. 3A.

Referring to FIG. 1, the display device 100 includes a liquid crystal panel 110, a gate driver circuit 120, a data driver circuit 130, a timing controller 140, a backlight unit 150, a backlight driver circuit 160, a camera 170, and a camera driver circuit 180. Hereinafter, the display device 100 according to an implementation of the present disclosure will be described based on an example in which the display device 100 includes the liquid crystal panel 110. Accordingly, the display device 100 as described below can refer to a liquid crystal display device 100.

In more detail, the liquid crystal panel 110 is a display panel for displaying an image, and includes a plurality of pixels P arranged in a matrix form along a plurality of row lines and a plurality of column lines. The liquid crystal panel 110 includes a first substrate and a second substrate facing each other while a liquid crystal layer is interposed therebetween. The first substrate is a lower substrate and corresponds to an array substrate, and an array element for driving each pixel P is disposed on the first substrate. In addition, the second substrate is an upper substrate facing the first substrate, and corresponds to a color filter substrate, and a color filter pattern for generating a color corresponding to each pixel P is disposed on the second substrate.

As shown in FIG. 1, a plurality of gate lines GL extending in a first direction (e.g., a row direction) and a plurality of data lines DL extending in a second direction (e.g., a column direction) intersecting the first direction are disposed on the array substrate of the liquid crystal panel 110. Also, each pixel P is disposed in each area where each of the plurality of gate lines GL and each of the plurality of data lines DL intersect.

Further, the plurality of pixels P can include a red (R) pixel displaying red, a green (G) pixel displaying green, and a blue (B) pixel displaying blue. The R, G, and B pixels can be alternately arranged with each other along each row line, and the R, G, and B pixels that are arranged in a consecutive manner with each other can constitute an image display unit.

As shown, each pixel P includes a switching thin-film transistor T connected to the gate line GL and the data line DL, and a liquid crystal capacitor C1c connected to the switching thin-film transistor T. Also, the liquid crystal capacitor C1c includes a pixel electrode and a common electrode, and a liquid crystal layer positioned therebetween. The pixel electrode can be formed on the array substrate, and the common electrode can be formed on the array substrate or the color filter substrate. In addition, a storage capacitor Cst for maintaining the data voltage applied to the liquid crystal capacitor C1c is disposed in each pixel P. Further, the switching thin-film transistor T is turned on based on a gate voltage applied through the gate line GL, and in synchronization therewith, a data voltage applied through the data line DL is applied to the pixel P. As described above, the liquid crystal operates under the electric field being generated via the application of the data voltage and the application of the common voltage to the common electrode to display an image.

Referring to FIGS. 2 and 3A, the liquid crystal panel 110 includes a display area DA in which an image is displayed, and a non-display area NA disposed along an outer edge of the display area DA and surrounding the display area DA. A plurality of pixels P are disposed in the display area DA to display an image. Further, the display area DA can include a first area DA1 entirely acting as a light emission area, and a second area DA2 at least partially surrounded by the first area DA1. The second area DA2 can overlap the camera 170 disposed under a lower surface of the liquid crystal panel 110.

Hereinafter, the first area DA1 in charge of the display function is referred to as a ‘general area’, and the second area DA2 overlapping the camera 170 is referred to as an ‘optical area’. At least a portion of an outer area of the optical area DA2 is surrounded by the general area DA1. In addition, the optical area DA2 can include a camera area DA2-1 and a peripheral area DA2-2. In particular, the camera area DA2-1 overlaps the camera 170. In the camera area DA2-1, a light source is not disposed under the lower surface of the liquid crystal panel 110. Further, the camera area DA2-1 refers to a ‘light-transmissive area’ DA2-1 through which light transmits. As shown in FIG. 2, the peripheral area DA2-2 surrounds the periphery of the camera area DA2-1. In the peripheral area DA2-2, a second backlight 152 can be disposed under a lower surface of the liquid crystal panel 110. In this instance, the peripheral area DA2-2 can act as a light-emitting area.

In addition, the non-display area NA can be disposed to surround the display area DA while being disposed around the outer periphery of the display area DA. Further, the non-display area NA includes a plurality of connection interfaces (e.g., a pad, a pin, etc.) connected to lines extending to the display area DA for driving the plurality of pixels P, a driver circuit for driving the display panel such as the gate driver 120 and the data driver 130, etc.

Referring back to FIG. 1, the gate driver circuit 120 can be embodied as a thin-film transistor in the non-display area NA and can be implemented in a gate-in-panel (GIP) manner. In particular, the gate driver circuit 120 sequentially outputs the gate voltage to the gate line GL according to the gate control signal GCS supplied from the timing controller 140. The gate driver circuit 120 can also be directly formed on the array substrate of the liquid crystal panel 110 in a GIP manner, or can be manufactured in an IC form and mounted on the array substrate.

Further, the data driver circuit 130 can be embodied as a data integrated circuit (IC), mounted on a printed circuit board separated from the substrate of the liquid crystal panel 110, and coupled to the connection interface disposed in the non-display area NA using a circuit film such as a flexible printed circuit board (FPCB), a chip-on-film (COF), a tape-carrier-package (TCP), or the like and can be positioned at a rear surface of the display device 100.

Also, the data driver circuit 130 receives the digital image data Da and the data control signal DCS output from the timing controller 140, and in response thereto, outputs a data voltage to a corresponding data line DL. For example, the data driver circuit 130 can convert the input image data Da into a parallel format according to the data control signal DCS, convert the converted image data into the parallel format into a positive/negative data voltage, and output the positive/negative data voltage to the corresponding data line DL.

In addition, the timing controller 140 receives synchronization signals such as a vertical synchronization signal Vsync, a horizontal synchronization signal Hsync, and a clock signal CLK and the image data Da from an external system. Also, the timing controller 140 generates and outputs the control signals GCS and DCS for controlling output timings of the gate driver circuit 120 and the data driver circuit 130, respectively, using the input synchronization signals. The timing controller 140 processes the image data Da and outputs the processed image data Da to the data driver circuit 120.

Further, the plurality of gate lines GL extending along the row direction are disposed in the display area DA of the liquid crystal panel 110, and the plurality of data lines DL extending along the column direction are disposed in the display area DA of the liquid crystal panel 110. In this instance, some of the gate lines GL and some of the data lines DL can extend across both the general area DA1 and the optical area DA2 of the display area DA. For example, first gate lines GLa as some of the plurality of gate lines GL, and first data lines DLa as some of the plurality of data lines DL are disposed only in the general area DA1 of the display area DA. Second gate lines GLb as the others of the plurality of gate lines GL, and second data lines DLb as the others of the plurality of data lines DL are disposed both in the general area DA1 and the optical area DA2.

In addition, the display device 100 can further include a power circuit for supplying a power voltage for driving each of the components of the display device. The backlight unit 150 is positioned under the liquid crystal panel 110 and supplies light to the liquid crystal panel 110. Also, the display device 100 according to an implementation of the present disclosure includes a first backlight 151 and the second backlight 152 that are controlled independently of each other.

Referring to FIG. 3A, the first backlight 151 can be disposed in the first area DA1 and under the liquid crystal panel 110, and the second backlight 152 can be disposed in the second area DA2 and under the liquid crystal panel 110. As shown, the camera 170 can be disposed under a lower surface of the liquid crystal panel 110 and adjacent to the second backlight 152.

Referring to FIGS. 2 and 3A, the second area DA2 can include the light-transmissive area DA2-1 and the peripheral area DA2-2. The light-transmissive area DA2-1 overlaps the camera 170 and thus the light source LS is not disposed under the lower surface of the liquid crystal panel 110 in the light-transmissive area DA2-1. Also, the peripheral area DA2-2 surrounds the periphery of the light-transmissive area DA2-1, and the second backlight 152 is disposed under a lower surface of the liquid crystal panel 110 in the peripheral area DA2-2.

In addition, the first backlight 151 can include a plurality of first light sources 151-1 to 151-n emitting light of the same color, and the second backlight 152 can include a plurality of second light sources 152-1 to 152-m emitting light of different colors. The first light sources 151-1 to 151-n and the second light sources 152-1 to 152-m can also emit light of different colors. Further, the first light sources 151-1 to 151-n can be denoted by “DA1_BL(W)”, and the second light sources 152-1 to 152-m can be denoted “DA2_BL(R)”, “DA2_BL(G)”, and “DA2_BL(B)”.

The first backlight 151 includes, as the light sources, a plurality of LEDs 151-1 to 151-n that emit light of a different color from a color of light emitted from the light source included in the second backlight 152. In this instance, the first backlight 151 includes a plurality of white (W) LEDs emitting white light. Also, the second backlight 152 includes, as the light sources, a plurality of LEDs 152-1 to 152-n that emit light of different colors, respectively. In this instance, the light sources of the second backlight 152 include a plurality of red (R) LEDs emitting red light, a plurality of green (G) LEDs emitting green light, and a blue (B) LEDs emitting blue light. Also, each LED can include an inorganic or organic light-emitting material.

Each of the first backlight 151 and the second backlight 152 is a direct type backlight in which a plurality of LEDs are disposed under the lower surface of the liquid crystal panel 110 and arranged to face the liquid crystal panel 110 and emits light beams toward the liquid crystal panel 110. A plurality of LEDs included in each of the first backlight 151 and the second backlight 152 are respectively connected to a plurality of output channels of the backlight driver circuit 160. In addition, a driving current Id output from each output channel of the backlight driver circuit 160 is individually applied to each of the plurality of LEDs included in each of the first backlight 151 and the second backlight 152.

Accordingly, each of the plurality of LEDs included in each of the first backlight 151 and the second backlight 152 can emit light based on the driving current Id individually applied thereto. Further, the backlight driver circuit 160 generates the driving current Id, outputs the driving current Id through each output channel, and supplies the driving current Id to a corresponding light source (that is, LED).

Referring to FIGS. 3A and 3B, the liquid crystal panel 110 includes a liquid crystal cell 111 including first and second substrates 111a and 111b facing each other, and a first polarizing plate 113 and a second polarizing plate 115 facing each other while the liquid crystal cell 111 is interposed therebetween. The first and second polarizing plates 113 and 115 can be attached to outer surfaces of the first substrate 111a and the second substrate 111b, respectively, and can selectively transmit only a specific light beam therethrough. For example, each of the first polarizing plate 113 and the second polarizing plate 115 can include a polarizing film having an absorption axis, and can absorb linearly polarized light parallel to the absorption axis and transmit linearly polarized light perpendicular thereto therethrough. The absorption axis of the first polarizing plate 113 and the absorption axis of the second polarizing plate 115 can be oriented to perpendicular to each other.

In addition, the first backlight 151, the second backlight 152, and the camera 170 can be disposed under the lower surface of the liquid crystal panel 110. The first backlight 151 is disposed under a lower surface of the general area DA1 of the liquid crystal panel 110, and the second backlight 152 is disposed under a lower surface of the optical area DA2 thereof. The first and second backlights 151 and 152 and the camera 170 can be arranged horizontally in a line.

Further, the display device 100 includes a camera module including the camera 170 disposed under the lower surface of the liquid crystal panel 110 and a camera sensor unit 180 (see FIG. 1) that converts light L input through the camera 170 into an electrical signal and processes the electrical signal. The camera 170 can be disposed to vertically overlap the light-transmissive area DA2-1 in the second area DA2, and a light receiving element of the camera 170 can face the liquid crystal panel 110. That is, the camera 170 can be disposed to vertically overlap the light-transmissive area DA2-1 of the optical area DA2, and the light receiving element (e.g., a lens) of the camera 170 can be disposed to face the liquid crystal panel 110. Therefore, a light traveling path to and from the camera 170 can be secured through the light-transmissive area DA2-1 defined in the display area DA.

Also, an optical sheet 155 can be disposed under the lower surface of the liquid crystal panel 110 and on top of the first and second backlights 151 and 152. The optical sheet 155 can include a first optical sheet 155a and a second optical sheet 155b. The first optical sheet 155a can be disposed between the first backlight 151 and the liquid crystal panel 110 and in the first area DA1, and the second optical sheet 155b can be disposed between the second backlight 152 and the liquid crystal panel 110 and in the second area DA2. That is, the first optical sheet 155a is disposed under a lower surface of the general area DA1 of the liquid crystal panel 110 and the second optical sheet 155b is disposed under a lower surface of the optical area DA2 of the liquid crystal panel 110. Also, the second optical sheet 155b can be disposed to vertically overlap not only the second backlight 152 but also the camera 170.

Each of the first optical sheet 155a and the second optical sheet 155b can include at least one prism sheet, and can transmit light incident thereto from each of the first backlight 151 and the second backlight 152 therethrough toward a light receiving surface of the liquid crystal panel 110. In this regard, the first optical sheet 155a and the second optical sheet 155b can transmit light therethrough so as to be incident to at least a portion of the light receiving surface in a substantially perpendicular manner thereto. Each of the first optical sheet 155a and the second optical sheet 155b can also include at least one condensing sheet and a diffuser sheet.

In addition, the first optical sheet 155a and the second optical sheet 155b can be patterned in different manners so as to have different light transmission characteristics. For example, the first optical sheet 155a can be patterned so as to transmit light incident thereto from the first backlight 151 therethrough toward the light receiving surface of the liquid crystal panel 110 in a perpendicular manner to the light receiving surface of the liquid crystal panel 110. Also, a portion of the second optical sheet 155b can be patterned so as to transmit light incident thereto from the second backlight 152 therethrough such that the light is refracted toward the light-transmissive area DA2-1 of the liquid crystal panel 110.

In this instance, the second optical sheet 155b can include a first pattern area PA1 patterned so as to transmit light incident thereto from the second backlight 152 therethrough such that the light is refracted by a predetermined angle toward the light-transmissive area DA2-1 of the liquid crystal panel 110, and a second pattern area PA2 patterned so as to transmit light incident thereto from the second backlight 152 therethrough toward the light receiving surface of the liquid crystal panel 110 in a perpendicular manner to the light receiving surface of the liquid crystal panel 110.

As illustrated in FIG. 3B, the first pattern area PA1 of the second optical sheet 155b can be located closer to the light-transmissive area DA2-1 than the second pattern area PA2 thereof. In addition, the first pattern area PA1 of the second optical sheet 155b can include at least one area. When the first pattern area PA1 of the second optical sheet 155b includes a plurality of areas, the plurality of areas can be patterned such that the light beam transmitting through the area closer to the light-transmissive area DA2-1 is refracted in a larger amount so as to be directed toward the light-transmissive area DA2-1.

As described above, the plurality of areas of the second optical sheet 155b can be patterned such that the light beam transmitting through the area closer to the light-transmissive area DA2-1 is refracted in a larger amount so as to be directed toward the light-transmissive area DA2-1 of the optical area DA2. Thus, the image of the pixel P can be displayed in an area vertically overlapping the light-transmissive area DA2-1 in which the second backlight 152 is not disposed under the lower surface of the liquid crystal panel 110, and the luminance uniformity in the optical area DA2 can be increased.

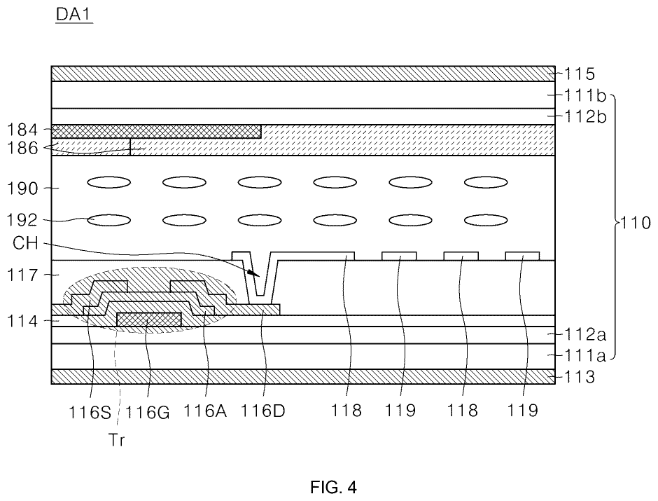

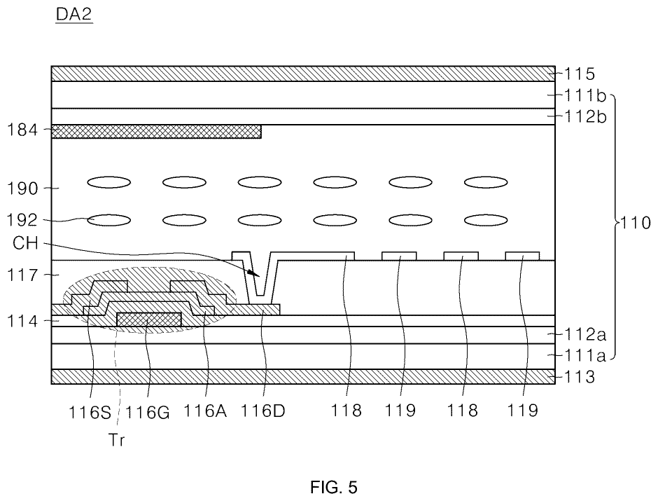

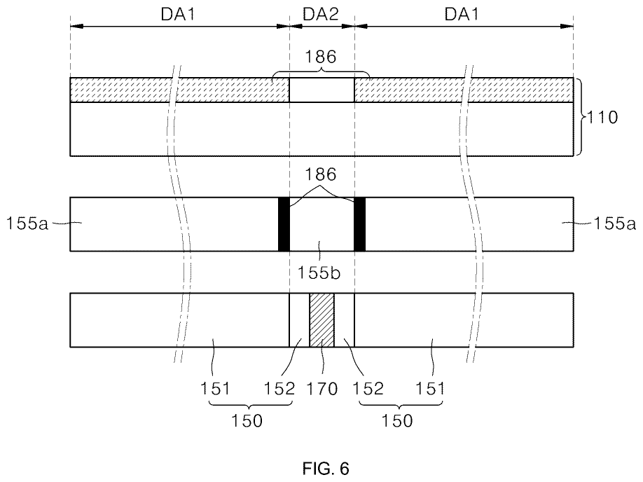

Next, FIG. 4 is a cross-sectional view schematically illustrating a general area of a liquid crystal panel and FIG. 5 is a cross-sectional view schematically illustrating an optical area of a liquid crystal panel according to an implementation of the present disclosure. Also, FIG. 6 is a cross-sectional view illustrating an arrangement structure of color filters included in the liquid crystal panel shown in FIG. 3A.

Hereinafter, a detailed structure of the liquid crystal panel 110 in the general area DA1 and the optical area DA2 according to an implementation of the present disclosure illustrated in FIG. 3A will be described in more detail with reference to FIGS. 4 to 6.

Referring to FIGS. 4 to 6, the liquid crystal panel 110 includes the liquid crystal cell including the first substrate 111a, the second substrate 111b, and the liquid crystal layer 190 interposed between the first and second substrates 111a and 111b and including liquid crystal molecules 192, and the first and second polarizer plates 113 and 115 respectively attached to both opposing surfaces in the vertical direction of the liquid crystal cell.

In addition, the first substrate 111a of the liquid crystal cell can be the array substrate or the lower substrate. Also, a first buffer layer 112a is formed on the first substrate 111a, and a thin-film transistor Tr is formed on the first buffer layer 112a. A gate electrode 116a of the thin-film transistor Tr is also disposed on the first buffer layer 112G. In this instance, a gate line connected to the gate electrode 116G can be disposed on the first buffer layer 112a. Further, the first buffer layer 112a can be omitted. In addition, a gate insulating film 114 is disposed on the first buffer layer 112a so as to cover the gate electrode 116G, and a semiconductor layer 116A of the thin-film transistor Tr is disposed on the gate insulating film 114 so as to vertically overlap the gate electrode 116G. Also, the semiconductor layer 116A can be made of an oxide semiconductor material and can include an active layer made of amorphous silicon and an ohmic contact layer made of impurity amorphous silicon.

As shown, a source electrode 116S and a drain electrode 116D of the thin-film transistor Tr are disposed on the gate insulating film 114 so as to be spaced apart from each other and so as to partially cover both opposing ends in the horizontal direction of the semiconductor layer 116A, respectively. In addition, the data line DL connected to the source electrode 116S can be disposed on the gate insulating film 114, and the data line DL can intersect the gate line GL so as to define the pixel area PA. A protective layer 117 having a drain contact hole CH defined therein exposing the drain electrode 116D is also disposed on the thin-film transistor Tr. Further, a pixel electrode 118 connected to the drain electrode 116D via the drain contact hole CH, and a common electrode 119 are disposed on the protective layer 117. In this regard, the pixel electrodes 118 and the common electrodes 119 are alternately arranged with each other in the horizontal manner. In addition, FIGS. 4 and 5 illustrate that the pixel electrode 118 and the common electrode 119 are disposed on the protective layer 117. However, implementations of the present disclosure are not limited thereto, and the pixel electrode 118 and the common electrode 119 can be disposed in different layers.

Further, the second substrate 111b of the liquid crystal cell can be a color filter substrate or the upper substrate. A second buffer layer 112b is also disposed on the second substrate 112b, and a black matrix 184 is disposed on the second buffer layer 112b so as to vertically overlap the thin-film transistor Tr, the gate line GL, the data line DL, etc. In addition, a color filter layer 186 is disposed on the second buffer layer 112b in a corresponding manner to or overlapping manner with the pixel area PA. The second buffer layer 112b and the black matrix 184 can also be omitted. In addition, the black matrix 184 can have an opening defined therein corresponding to and vertically overlapping the pixel area PA. The color filter layer 186 can include a red (R) color filter, a green (G) color filter, and a blue (B) color filter sequentially arranged in the horizontal plane. Each of the red (R) color filter, the green (G) color filter, and the blue (B) color filter can correspond to and vertically overlap the opening of the black matrix 184.

Referring to FIGS. 4 and 6, in a portion of the liquid crystal panel 110 in the general area DA1, the color filter layer 186 includes the plurality of color filters for displaying the different colors for the pixels P, respectively which correspond to or overlap the pixel areas, respectively. As shown, the liquid crystal layer 190 is interposed between the color filter layer 186 and the pixel areas.

In addition, referring to FIGS. 5 and 6, the color filter layer 186 may not be disposed on the second substrate 112b of the liquid crystal panel 110 in the optical area DA2. The black matrix 184 may also not be disposed on the second substrate 112b of the liquid crystal panel 110 in the optical area DA2. As described above, in the liquid crystal panel 110, the color filter layer is omitted in the optical area DA2 including the light-transmissive area DA2-1 serving as the light traveling path to and from the camera 170, so that the transmittance of light through the second substrate 112b to be incident onto the camera 170 can be greatly increased. In addition, in the optical area DA2, the second backlight 152 emitting light of different colors is disposed under the lower surface of the liquid crystal panel 110, so that an image of a pixel can be displayed based on the combination of the light beams of the different colors therefrom even in the optical area DA2 from which the color filter layer 186 is removed, thereby implementing a full screen display.

Further, the first and second substrates 111a and 111b are bonded to each other with the liquid crystal layer 190 interposed therebetween. Also, the orientations of the liquid crystal molecules 192 of the liquid crystal layer 190 are controlled under a horizontal electric field generated between the pixel electrode 118 and the common electrode 119. However, the common electrode 119 can be formed on the color filter layer 186 on the second substrate 116b, and accordingly, a vertical electric field can be generated between the pixel electrode 118 and the common electrode 119 to control the orientation of the liquid crystal molecules 192 of the liquid crystal layer 190.

Further, the first and second polarizing plates 113 and 115 having respective polarization axes perpendicular to each other are attached to the outer surfaces of the first and second substrates 111a and 111b, respectively. In addition, an alignment film can be further disposed in an area in contact with each of the first and second substrates 111a and 111b and the liquid crystal layer 190. Also, a seal pattern can be formed at an edge of each of the first and second substrates 111a and 111b to prevent leakage of the materials of the liquid crystal layer 190.

Referring to FIG. 6, a light blocking portion 186 can be disposed at an interface between the first optical sheet 155a disposed on the first backlight 151 in the general area DA1 and the second optical sheet 155b disposed on the second backlight 152 in the optical area DA2. For example, a black material layer as the light blocking portion 186 can be disposed between the first optical sheet 155a and the second optical sheet 155b facing each other, or a black ink as the light blocking portion 186 can be added to an interface between the first optical sheet 155a and the second optical sheet 155b facing each other.

Accordingly, when the liquid crystal panel 110 operates, light interference that can occur at the interface between the first backlight 151 including the white (W) LED and the second backlight 152 including the red (R) LED, the green (G) LED, and the blue (B) LED can be prevented, thereby securing high resolution.

In addition, FIG. 6 illustrates the camera 170 located in the middle of the display area. However, the camera 170 can be located on the left side or right side of the display, for example. Thus, the second backlight 152 would be disposed to correspond with the camera location on the left side or the right side. When the camera 170 is at an edge of the display region DA1 (right side in FIG. 6), the second backlight 152 can include a backlight unit adjacent to a left side of the camera 170 located at the edge of the display region DA1 (i.e., the second backlight 152 would not surround the camera 170 but only be disposed on the left side of the camera).

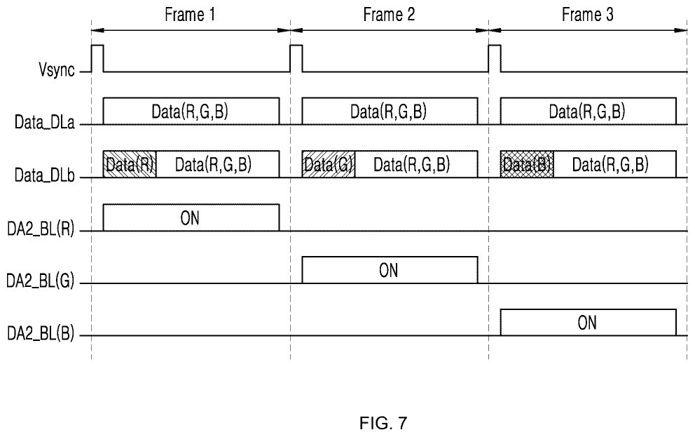

Hereinafter, an image display driving scheme and a camera driving scheme of the display device 100 according to an implementation of the present disclosure will be described with reference to FIGS. 7 to 9.

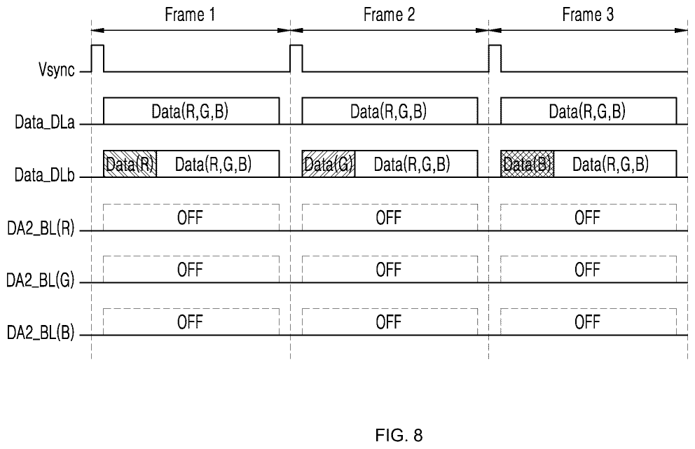

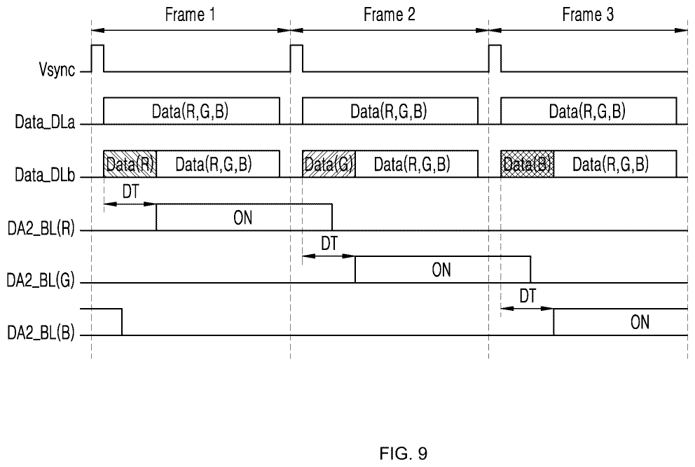

In particular, FIG. 7 is a timing diagram for illustrating an example of a backlight driving scheme in a camera-off state of a display device and FIG. 8 is a timing diagram for illustrating an example of a backlight driving scheme in a camera-on state of a display device according to an implementation of the present disclosure. FIG. 9 is a timing diagram for illustrating another example of a backlight driving scheme in a camera-on state of a display device according to an implementation of the present disclosure.

In more detail, the data driver circuit 130 respectively applies data signals (e.g., a data voltage) to the data line DLa disposed only in the general area DA1 of the liquid crystal panel 110 and the data line DLb disposed in both the general area DA1 and the optical area DA2, based on different driving frequencies, under the control of the timing controller 140. The data driver circuit 130 also applies the data signal on a frame basis of input image data.

In addition, the backlight driver circuit 160 drives the first backlight 151 and the second backlight 152 based on different driving frequencies. Further, the backlight driver circuit 160 can be synchronized with the data driver circuit 130 to control the operation of the first backlight 151 and the second backlight 152 on a frame basis.

Specifically, with reference to FIG. 7, an example in which a full white image is displayed in the display area DA of the liquid crystal panel 110 when the camera 170 is turned off will be described. When the vertical synchronization signal Vsync is input to the data driver circuit 130, the data driver circuit 130 simultaneously applies the data signals Data_DLa to a red (R) pixel, a green (G) pixel, and a blue (B) pixel via the corresponding data lines DLa disposed only in the general area DA1 to output a full white image in the general area DA1. In this regard, the data driver circuit 130 simultaneously applies the data signals Data_DLa to a red (R) pixel, a green (G) pixel, and a blue (B) pixel via the data lines DLa disposed only in the general area DA1 for each of successive frames. However, the data driver circuit 130 separately applies a data signal to the general area DA1 and a data signal to the optical area DA2.

Referring to FIG. 7, the data signals Data_DLa are simultaneously applied to the red (R) pixel, the green (G) pixel, and the blue (B) pixel via the corresponding data lines DLa for an entire period of each frame. At the same time, when the vertical synchronization signal Vsync is input to the backlight driver circuit 160, the backlight driver circuit 160 can turn on all of white (W) LEDs of the first backlight 151 disposed in the general area DA1 for each frame.

Meanwhile, when the vertical synchronization signal Vsync is input to the data driver circuit 130, the data driver circuit 130 applies the data signal Data_DLb to one of the R (red) pixel, the G (green) pixel, and the B (blue) pixel in the optical area DA2 via the corresponding data line DLb disposed in both the general area DA1 and the optical area DA2 for a portion of one frame Frame 1. Sequentially and subsequently, the data driver circuit 130 simultaneously applies the data signals Data_DLb to a red (R) pixel, a green (G) pixel, and a blue (B) pixel in the general area DA1 via the corresponding data lines DLb disposed in both the general area DA1 and the optical area DA2 for a subsequent portion of one frame Frame 1. Then, for a next fame Frame 2, the data driver circuit 130 applies the data signal Data_DLb to another of the R (red) pixel, the G (green) pixel, and the B (blue) pixel in the optical area DA2 via the corresponding data line DLb disposed in both the general area DA1 and the optical area DA2 for a portion of the next frame Frame 2.

Sequentially and subsequently, the data driver circuit 130 simultaneously applies the data signals Data_DLb to a red (R) pixel, a green (G) pixel, and a blue (B) pixel in the general area DA1 via the corresponding data lines DLb disposed in both the general area DA1 and the optical area DA2 for a subsequent portion of the next frame Frame 2. Then, for a further next fame Frame 3, the data driver circuit 130 applies the data signal Data_DLb to the rest of the R (red) pixel, the G (green) pixel, and the B (blue) pixel in the optical area DA2 via the corresponding data line DLb disposed in both the general area DA1 and the optical area DA2 for a portion of the further next frame Frame 3. Sequentially and subsequently, the data driver circuit 130 simultaneously applies the data signals Data_DLb to a red (R) pixel, a green (G) pixel, and a blue (B) pixel in the general area DA1 via the corresponding data lines DLb disposed in both the general area DA1 and the optical area DA2 for a subsequent portion of the further next frame Frame 3.

More specifically, as shown in FIG. 7, the data driver circuit 130 applies the data signal Data_DLb to the R (red) pixel in the optical area DA2 via the corresponding data line DLb disposed in both the general area DA1 and the optical area DA2 for an initial period of one frame Frame 1. Sequentially and subsequently, the data driver circuit 130 simultaneously applies the data signals Data_DLb to a red (R) pixel, a green (G) pixel, and a blue (B) pixel in the general area DA1 via the corresponding data lines DLb disposed in both the general area DA1 and the optical area DA2 for a subsequent remaining period of one frame Frame 1.

Then, for a next fame Frame 2, the data driver circuit 130 applies the data signal Data_DLb to the G (green) pixel in the optical area DA2 via the corresponding data line DLb disposed in both the general area DA1 and the optical area DA2 for an initial period of the next frame Frame 2. Sequentially and subsequently, the data driver circuit 130 simultaneously applies the data signals Data_DLb to a red (R) pixel, a green (G) pixel, and a blue (B) pixel in the general area DA1 via the corresponding data lines DLb disposed in both the general area DA1 and the optical area DA2 for a subsequent and remaining period of the next frame Frame 2.

Then, for a further next fame Frame 3, the data driver circuit 130 applies the data signal Data_DLb to the B (blue) pixel in the optical area DA2 via the corresponding data line DLb disposed in both the general area DA1 and the optical area DA2 for an initial period of the further next frame Frame 3. Sequentially and subsequently, the data driver circuit 130 simultaneously applies the data signals Data_DLb to a red (R) pixel, a green (G) pixel, and a blue (B) pixel in the general area DA1 via the corresponding data lines DLb disposed in both the general area DA1 and the optical area DA2 for a subsequent and remaining period of the further next frame Frame 3.

At the same time, when the vertical synchronization signal Vsync is input to the backlight driver circuit 160, the backlight driver circuit 160 can turn on one of the red (R) LED, the green (G) LED, and the blue (B) LED of the second backlight 152 disposed in the optical area DA2 for each frame. In this regard, the turned on one among the red (R) LED, the green (G) LED, and the blue (B) LED of the second backlight 152 can correspond to one of the R (red) pixel, the G (green) pixel, and the B (blue) pixel in the optical area DA2 to which the data signal Data_DLb is applied for the initial period of each frame.

More specifically, as shown in FIG. 7, for the first frame Frame 1, the backlight driver circuit 160 can output a driving signal DA2_BL(R) for turning on the R (red) LED of the second backlight 152 disposed in the optical area DA2 to the second backlight 152 for the same time duration for which the data signal Data_DLb is applied to the R (red) pixel in the optical area DA2 and sequentially and subsequently, the data signals Data_DLb are simultaneously applied to a red (R) pixel, a green (G) pixel, and a blue (B) pixel in the general area DA1.

Subsequently, for the second frame Frame 2, the backlight driver circuit 160 can output a driving signal DA2_BL(G) for turning on the G (green) LED of the second backlight 152 disposed in the optical area DA2 to the second backlight 152 for the same time duration for which the data signal Data_DLb is applied to the G (green) pixel in the optical area DA2, and sequentially and subsequently, the data signals Data_DLb are simultaneously applied to a red (R) pixel, a green (G) pixel, and a blue (B) pixel in the general area DA1.

Subsequently, for the third frame Frame 3, the backlight driver circuit 160 can output a driving signal DA2_BL(B) for turning on the B (blue) LED of the second backlight 152 disposed in the optical area DA2 to the second backlight 152 for the same time duration for which the data signal Data_DLb is applied to the B (blue) pixel in the optical area DA2, and sequentially and subsequently, the data signals Data_DLb are simultaneously applied to a red (R) pixel, a green (G) pixel, and a blue (B) pixel in the general area DA1.

For each of the first frame Frame 1 to the third frame Frame 3, all of the white (W) LEDs of the first backlight 151 can be turned on. When the camera 170 is turned off, the backlight driver circuit 160 can turn on the second light source DA2_BL(R) corresponding to the first color Red of the second backlight 152 for the first frame Frame 1, and can turn off the second light sources DA2_BL(G) and DA2_BL(B) corresponding to the second color Green and the third color Blue for the first frame Frame 1.

When the camera 170 is turned off, the backlight driver circuit 160 can turn on the second light source DA2_BL(G) corresponding to the second color Green of the second backlight 152 for the second frame Frame2, and can turn off the second light sources DA2_BL(R) and DA2_BL(B) corresponding to the first color Red and the third color Blue for the second frame Frame2. When the camera 170 is turned off, the backlight driver circuit 160 can turn on the second light source DA2_BL(B) corresponding to the third color Blue of the second backlight 152 for the third frame Frame 3, and can turn off the second light sources DA2_BL(R) and DA2_BL(G) corresponding to the first color Red and the second color Green for the third frame Frame 3.

Referring to FIG. 9, in consideration of the liquid crystal response of the liquid crystal layer 190 of the liquid crystal panel 110, the backlight driver circuit 160 can apply a delay time DT to each of the red (R) LED, green (G) LED, and blue (B) LED of the second backlight 152 for a predetermined period (e.g., 0.5 frames) from a time point at which the data signal Data_DLb is applied for each frame. Referring to FIG. 9, for the first frame Frame 1, after the delay time DT has elapsed from a time point at which the data signal DATA(R) as the data signal Data_DLb starts to be applied to the R (red) pixel in the optical area DA2, the driving signal DA2_BL(R) for turning on the R (red) LED can be output. For the second frame Frame 2, after the delay time DT has elapsed from a time point at which the data signal DATA(G) as the data signal Data_DLb starts to be applied to the G (green) pixel in the optical area DA2, the driving signal DA2_BL(G) for turning on the G (green) LED can be output. For the third frame Frame 3, after the delay time DT has elapsed from a time point at which the data signal DATA(B) as the data signal Data_DLb starts to be applied to the B (blue) pixel in the optical area DA2, the driving signal DA2_BL(B) for turning on the B (blue) LED can be output.

In FIG. 8, a full white image is displayed in the display area DA of the liquid crystal panel 110 when the camera 170 is turned on will be described by way of example. When the vertical synchronization signal Vsync is input to the data driver circuit 130, the data driver circuit 130 simultaneously applies the data signals Data_DLa to a red (R) pixel, a green (G) pixel, and a blue (B) pixel via the corresponding data lines DLa disposed only in the general area DA1 to output a full white image in the general area DA1. In this regard, the data driver circuit 130 simultaneously applies the data signals Data_DLa to a red (R) pixel, a green (G) pixel, and a blue (B) pixel via the data lines DLa disposed only in the general area DA1 for each of successive frames. However, the data driver circuit 130 separately applies a data signal to the general area DA1 and a data signal to the optical area DA2.

Referring to FIG. 8, the data signals Data_DLa are simultaneously applied to the red (R) pixel, the green (G) pixel, and the blue (B) pixel via the corresponding data lines DLa for an entire period of each frame. At the same time, when the vertical synchronization signal Vsync is input to the backlight driver circuit 160, the backlight driver circuit 160 can turn on all of white (W) LEDs of the first backlight 151 disposed in the general area DA1 for each frame. That is, when the camera 170 is turned on, the data driver circuit 130 operates in the same manner regarding the general area DA1 as the manner in which the data driver circuit 130 operates when the camera 170 is turned off.

In addition, when the camera 170 is turned on, the data driver circuit 130 inputs a data signal for outputting a black image to one of a red (R) pixel, a green (G) pixel, and a blue (B) pixel in the peripheral area DA2-2 of the optical area DA2 via the data line DLb disposed in the general area DA1 and the optical area DA2 for a portion of one frame and, at the same time, inputs a data signal for outputting a white image to one of a red (R) pixel, a green (G) pixel, and a blue (B) pixel in the light-transmissive area DA2-1 of the optical area DA2 via the data line DLb disposed in the general area DA1 and the optical area DA2 for the portion of one frame.

Subsequently, the data driver circuit 130 inputs a data signal for outputting a black image to another of a red (R) pixel, a green (G) pixel, and a blue (B) pixel in the peripheral area DA2-2 of the optical area DA2 via the data line DLb disposed in the general area DA1 and the optical area DA2 for a portion of the next frame and, at the same time, inputs a data signal for outputting a white image to another of a red (R) pixel, a green (G) pixel, and a blue (B) pixel in the light-transmissive area DA2-1 of the optical area DA2 via the data line DLb disposed in the general area DA1 and the optical area DA2 for the portion of the next frame. Subsequently, the data driver circuit 130 inputs a data signal for outputting a black image to the rest of a red (R) pixel, a green (G) pixel, and a blue (B) pixel in the peripheral area DA2-2 of the optical area DA2 via the data line DLb disposed in the general area DA1 and the optical area DA2 for a portion of the further next frame and, at the same time, inputs a data signal for outputting a white image to the rest of a red (R) pixel, a green (G) pixel, and a blue (B) pixel in the light-transmissive area DA2-1 of the optical area DA2 via the data line DLb disposed in the general area DA1 and the optical area DA2 for the portion of the further next frame.

For example, the data driver circuit 130 inputs a data signal for outputting a black image to a red (R) pixel in the peripheral area DA2-2 of the optical area DA2 via the data line DLb disposed in the general area DA1 and the optical area DA2 for a portion of the first frame Frame 1 and, at the same time, inputs a data signal for outputting a white image to a red (R) pixel in the light-transmissive area DA2-1 of the optical area DA2 via the data line DLb disposed in the general area DA1 and the optical area DA2 for the portion of the first frame Frame 1. Subsequently, the data driver circuit 130 inputs a data signal for outputting a black image to a green (G) pixel in the peripheral area DA2-2 of the optical area DA2 via the data line DLb disposed in the general area DA1 and the optical area DA2 for a portion of the second frame Frame 2 and, at the same time, inputs a data signal for outputting a white image to a green (G) pixel in the light-transmissive area DA2-1 of the optical area DA2 via the data line DLb disposed in the general area DA1 and the optical area DA2 for the portion of the second frame Frame 2.

Subsequently, the data driver circuit 130 inputs a data signal for outputting a black image to a blue (B) pixel in the peripheral area DA2-2 of the optical area DA2 via the data line DLb disposed in the general area DA1 and the optical area DA2 for a portion of the third frame Frame 3 and, at the same time, inputs a data signal for outputting a white image to a blue (B) pixel in the light-transmissive area DA2-1 of the optical area DA2 via the data line DLb disposed in the general area DA1 and the optical area DA2 for the portion of the third frame Frame 3. In this example, the order of the pixels to which the data signal for outputting a black or white image is input is the order of the red, green, and blue pixels. However, implementations of the present disclosure are not limited thereto.

Subsequently, the data driver circuit 130 inputs a data signal for outputting a black image to a red (R) pixel, a green (G) pixel, and a blue (B) pixel in the peripheral area DA2-2 of the optical area DA2 via the data lines DLb disposed in the general area DA1 and the optical area DA2 for a subsequent portion of one frame and, at the same time, inputs a data signal for outputting a white image to a red (R) pixel, a green (G) pixel, and a blue (B) pixel in the light-transmissive area DA2-1 of the optical area DA2 via the data lines DLb disposed in the general area DA1 and the optical area DA2 for the subsequent portion of one frame. Subsequently, the data driver circuit 130 inputs a data signal for outputting a black image to a red (R) pixel, a green (G) pixel, and a blue (B) pixel in the peripheral area DA2-2 of the optical area DA2 via the data lines DLb disposed in the general area DA1 and the optical area DA2 for a subsequent portion of the next frame and, at the same time, inputs a data signal for outputting a white image to a red (R) pixel, a green (G) pixel, and a blue (B) pixel in the light-transmissive area DA2-1 of the optical area DA2 via the data lines DLb disposed in the general area DA1 and the optical area DA2 for the subsequent portion of the next frame.

Subsequently, the data driver circuit 130 inputs a data signal for outputting a black image to a red (R) pixel, a green (G) pixel, and a blue (B) pixel in the peripheral area DA2-2 of the optical area DA2 via the data lines DLb disposed in the general area DA1 and the optical area DA2 for a subsequent portion of the further next frame and, at the same time, inputs a data signal for outputting a white image to a red (R) pixel, a green (G) pixel, and a blue (B) pixel in the light-transmissive area DA2-1 of the optical area DA2 via the data lines DLb disposed in the general area DA1 and the optical area DA2 for the subsequent portion of the further next frame.

For example, the data driver circuit 130 inputs a data signal for outputting a black image to a red (R) pixel, a green (G) pixel, and a blue (B) pixel in the peripheral area DA2-2 of the optical area DA2 via the data lines DLb disposed in the general area DA1 and the optical area DA2 for a subsequent portion of the first frame Frame 1 and, at the same time, inputs a data signal for outputting a white image to a red (R) pixel, a green (G) pixel, and a blue (B) pixel in the light-transmissive area DA2-1 of the optical area DA2 via the data lines DLb disposed in the general area DA1 and the optical area DA2 for the subsequent portion of the first frame Frame 1. Subsequently, the data driver circuit 130 inputs a data signal for outputting a black image to a red (R) pixel, a green (G) pixel, and a blue (B) pixel in the peripheral area DA2-2 of the optical area DA2 via the data lines DLb disposed in the general area DA1 and the optical area DA2 for a subsequent portion of the second frame Frame 2 and, at the same time, inputs a data signal for outputting a white image to a red (R) pixel, a green (G) pixel, and a blue (B) pixel in the light-transmissive area DA2-1 of the optical area DA2 via the data lines DLb disposed in the general area DA1 and the optical area DA2 for the subsequent portion of the second frame Frame 2.

Subsequently, the data driver circuit 130 inputs a data signal for outputting a black image to a red (R) pixel, a green (G) pixel, and a blue (B) pixel in the peripheral area DA2-2 of the optical area DA2 via the data lines DLb disposed in the general area DA1 and the optical area DA2 for a subsequent portion of the third frame Frame 3 and, at the same time, inputs a data signal for outputting a white image to a red (R) pixel, a green (G) pixel, and a blue (B) pixel in the light-transmissive area DA2-1 of the optical area DA2 via the data lines DLb disposed in the general area DA1 and the optical area DA2 for the subsequent portion of the third frame Frame 3.

That is, when the camera 170 is turned on, the data driver circuit 130 sequentially applies data signals for outputting a black image respectively to a red (R) pixel, a green (G) pixel, and a blue (B) pixel in the peripheral area DA2-2 of the optical area DA2 for the successive frames, and at the same time, sequentially applies data signals for outputting a white image respectively to a red (R) pixel, a green (G) pixel, and a blue (B) pixel in the light-transmissive area DA2-1 for the successive frames. Subsequently, the data driver circuit simultaneously applies data signals for outputting a black image to a red (R) pixel, a green (G) pixel, and a blue (B) pixel in the peripheral area DA2-2 of the optical area DA2 for each of the successive frames, and at the same time, simultaneously applies data signals for outputting a white image to a red (R) pixel, a green (G) pixel, and a blue (B) pixel in the light-transmissive area DA2-1 for each of the successive frames.

Accordingly, when the camera 170 is turned on, the white image can be output in the light-transmissive area DA2-1 to increase the transmittance of the light-transmissive area DA2-1 to obtain the maximum amount of light incident on the camera 170. Meanwhile, the black image can be output in the peripheral area DA2-2 of the optical area DA2 to prevent the camera 170 of the light-transmissive area DA2-1 from being visually recognized by the user.

In the above description, an example in which when the camera 170 is turned on, the data signals corresponding to input image data are simultaneously applied to a red (R) pixel, a green (G) pixel, and a blue (B) pixel in the entirety of the general area DA1 has been described. However, the present disclosure is not limited thereto. In another example, in order to naturally express the optical area DA2 in terms of the user interface, a black image can be output in a portion of the general area DA1 adjacent to the optical area DA2. For example, along the entire display area DA, the optical area DA2 can be positioned adjacent to the non-display area NA. In this case, the data driver circuit 130 can apply a data signal for outputting a black image to a partial area of the general area DA1 adjacent to the non-display area NA and overlapping the optical area DA2 in the column direction or the row direction.

Further, the backlight driver circuit 160 can independently drive the first backlight 151 and the second backlight 152. Also, the backlight driver circuit 160 can turn off all of the plurality of second light sources R, G, and B when the camera 170 is turned on.

In addition, when the camera 170 is turned on, the backlight driver circuit 160 outputs the driving signals DA2_BL(R), DA2_BL(G), and DA2_BL(B) for turning off all of R(red) LED, G(green) LED, and B(blue) LED of the second backlight 152 disposed in the optical area DA2 for each frame. Accordingly, a light traveling path to and from the camera 170 can be secured due to the light-transmissive area DA2-1, and the light from the backlight can be prevented from interfering with the light incident on the camera 170. In this instance, the backlight driver circuit 160 independently controls the first backlight 151 disposed in the general area DA1 regardless of whether the camera 170 is turned on or turned off. That is, the backlight driver circuit 160 can turn on the plurality of white (W) LEDs of the first backlight 151 for the image displaying for each frame.

Hereinabove, an example in which the camera 170 is disposed to vertically overlap the light-transmissive area DA2-1 of the liquid crystal panel 110 in the display device 100 according to an implementation of the present disclosure has been described. However, the area in which the camera is disposed is not limited to the position under the display area of the display panel.

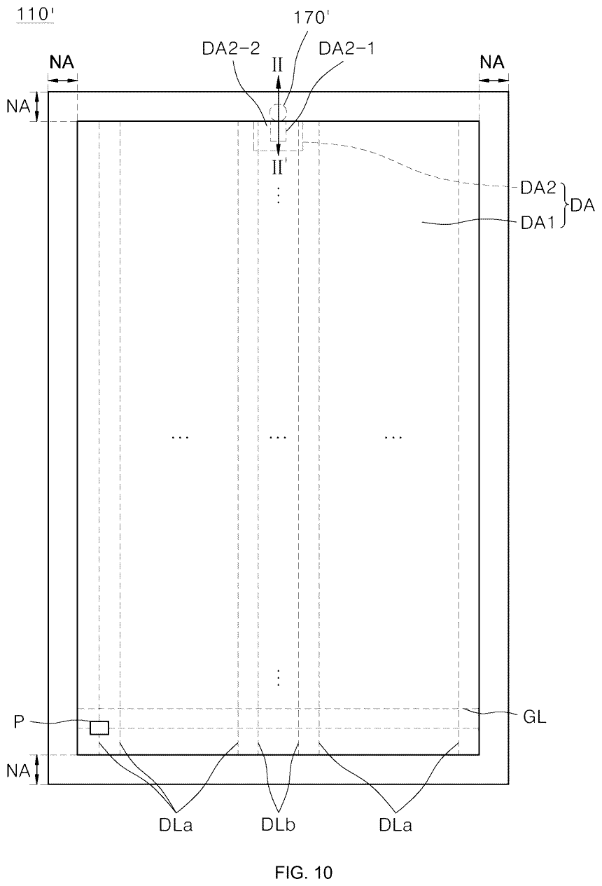

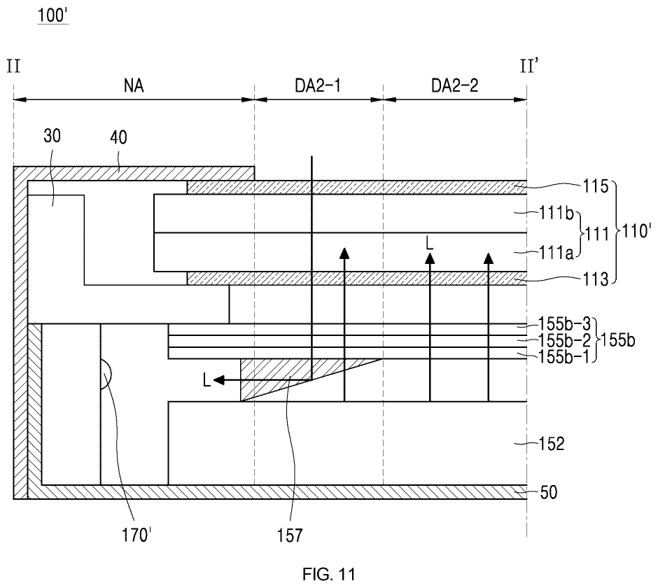

Hereinafter, a camera placement structure in a display device according to another implementation of the present disclosure will be described. However, the display device according to another implementation of the present disclosure includes the same or similar components and corresponding features as or to those of the display device according to the above implementation of the present disclosure, except that the camera is disposed in the non-display area NA and an optical prism unit is further disposed to secure the camera light traveling path. Therefore, for convenience, descriptions of components duplicate with the display device according to the above implementation of the present disclosure and the features thereof will be omitted. In addition, when each of the components of the display device according to another implementation of the present disclosure as illustrated in FIGS. 10 and 11 to be described below, and each of the components of the display device 100 according to the above implementation of the present disclosure as described above with reference to FIGS. 1 to 9 can use the same reference numerals, the former and the latter can mean substantially the same component.

In more detail, FIG. 10 is a plan view schematically illustrating a liquid crystal panel of a display device and FIG. 11 is a cross-sectional view taken along a line II-II′ of FIG. 10, and is a cross-sectional view schematically illustrating a display device according to another implementation of the present disclosure.

Referring to FIGS. 10 and 11 together, a display device 100′ according to another implementation of the present disclosure includes a main frame 30, a top frame 40, and a bottom frame 50, a liquid crystal panel 110′ and a backlight unit (referring to a second backlight 152 in FIG. 11). In the regard, the liquid crystal panel 110′ and the backlight unit can be received in a space defined via assembly and coupling of the main frame 30, the top frame 40, and the bottom frame 50 and thus can be modularized into a module.

For example, as illustrated in FIG. 11, the main frame 30 can have a rectangular frame shape and can include a vertical portion and a horizontal portion. The liquid crystal panel 110′ is positioned on the horizontal portion of the main frame 30, the second backlight 152 is positioned on the horizontal portion thereof, and the vertical portion of the main frame 30 can surround the side surface of the liquid crystal panel 110′. In addition, the bottom frame 50 includes a horizontal surface on which the backlight 152 is seated and a side surface perpendicular thereto. Also, the top frame 40 can110′ can have a rectangular frame shape in a plan view and can have an inverted L-shaped cross section so as to cover the front edge and a side surface of the liquid crystal panel. The top frame 40 also includes an opening defined in a center of the front surface thereof so that an image displayed from the liquid crystal panel 110′ is displayed to the outside through the opening. However, the top frame 40 can be omitted. The top frame 40 can be referred to as a case top, a top case, or a top cover, the main frame 30 can be referred to as a guide panel or a main support, and the bottom frame 50 can be referred to as a cover bottom or a bottom cover. This structure of the display device 100′ can be equally applied to the display device 100 according to the above implementation of the present disclosure as described above with reference to FIGS. 1 to 9.

Further, the liquid crystal panel 110′ can include a first substrate 111a and a second substrate 111b, and first and second polarizing plates 113 and 115 positioned on outer surfaces of the two substrates 111a and 11ab, respectively, and can further include the same components as the liquid crystal panel 110 as described above with reference to FIGS. 4 to 6.

In addition, in the liquid crystal panel 110′, an optical sheet (referring to the second optical sheet 155b in FIG. 11) can be disposed above the backlight unit, and the optical sheet can include a plurality of optical sheets. For example, the optical sheet can include first to third optical sheets 155b-1, 155b-2, and 155b-3, and for example, each of the first and second optical sheets 155b-1 and 155b-2 can be a condensing sheet, and the third optical sheet 155b-3 can be a diffuser sheet. The condensing sheet can include a prism pattern or a lenticular pattern, the first optical sheet 155b-1 can include a lenticular pattern, and the second optical sheet 115b-2 can include a prism pattern. The third optical sheet 115b-3 can be a luminance enhancement film.

Further, the luminance enhancement film can have a structure in which layers having different refractive indices are alternately stacked on top of each other. The structure of the optical sheet 155b can be applied to an area (i.e., the second pattern area PA2), located relatively far from the light-transmissive area DA2-1, of the peripheral area DA2-2 of the optical area DA2. In addition, the structure of the optical sheet 155b can be similarly applied to an area (i.e., the first pattern area PA1) of the peripheral area DA2-2 relatively close to the light-transmissive area DA2-1. However, the patterns to obtain the light refractive index in the above two areas of the optical sheet 155b can be different from each other. In addition, the structure of the optical sheet 155b can be similarly applied to the optical sheet 155a corresponding to the general area DA1. However, the pattern for obtaining the light refractive index in the optical sheet 155a can be different from the pattern for obtaining the light refractive index in the optical sheet 155b.

In the display device 100′ according to another implementation of the present disclosure, the camera 170′ can be disposed under a lower surface of the liquid crystal panel 110′, but can be disposed not in the display area DA but outside the display area DA, that is, can be disposed in one side area of the non-display area NA. For example, although FIG. 11 illustrates that the camera 170′ is disposed on the side surface of the bottom frame 50, the position of the camera 170′ is not limited thereto but can be anywhere in the non-display area NA of the liquid crystal panel 110′. In addition, the light receiving element of the camera 170′ can be is oriented to face the light-transmissive area DA2-1 in a direction perpendicular to the direction in which the second backlight 152 emits light. However, implementations of the present disclosure are not limited thereto. That is, the camera 170′ can be oriented such that the light receiving element is oriented so as to face in a perpendicular manner to the light receiving surface of the liquid crystal panel 110′.

In this instance, the light-transmissive area DA2-1 constituting a light traveling path to and from the camera 170′ is still in the display area DA. Referring to FIG. 10, the optical area DA2 can be disposed in one side area of the display area DA adjacent to a portion of the non-display area NA in which the camera 170′ is disposed. Also, the light-transmissive area DA2-1 can be disposed in a portion of a side edge area of the display area DA adjacent to and aligned with the camera 170′ in the column direction of the display device.

In addition, the display device 100′ according to another implementation of the present disclosure can include an optical prism 157 disposed under the liquid crystal panel 110 in the second area DA2 and disposed above the second backlight 152 in the second area DA2. In particular, the optical prism 157 includes a reflective surface that reflects light incident from the outside toward the light receiving element of the camera 170′, where the reflective surface is disposed under the liquid crystal panel 110′ and above the second backlight 152 in the light-transmissive area DA2-1. An inclination angle of the reflective surface of the optical prism 157 can be, for example, 45 degrees with respect to incident light, that is, with respect to a direction perpendicular to the light receiving surface of the liquid crystal panel 110′. In addition, the optical prism 157 transmits the light emitted from the second backlight 152 toward the light receiving surface of the liquid crystal panel 110′. The optical sheet 155b can be disposed above the optical prism 157.

As described above, in the display device 100′ according to another implementation of the present disclosure, the camera 170′ is disposed in the non-display area NA and under the liquid crystal panel 110′, and the optical prism 157 transmits the light of the second backlight 152 toward the light-transmissive area DA2-1 and reflects the light incident from the outside toward the light receiving element of the camera 170′, so that the light path along which the light is incident on the camera 170′ and the light path along which the light from the light source is emitted toward the receiving surface of the liquid crystal panel 110′ are isolated from each other, thereby effectively increasing the luminance uniformity in the optical area. In addition, an image of the pixel can be displayed not only in the peripheral area DA2-2 of the optical area DA2 but also in the light-transmissive area DA2-1, thereby increasing the resolution in the optical area DA2 and implementing a high-efficiency full screen display.

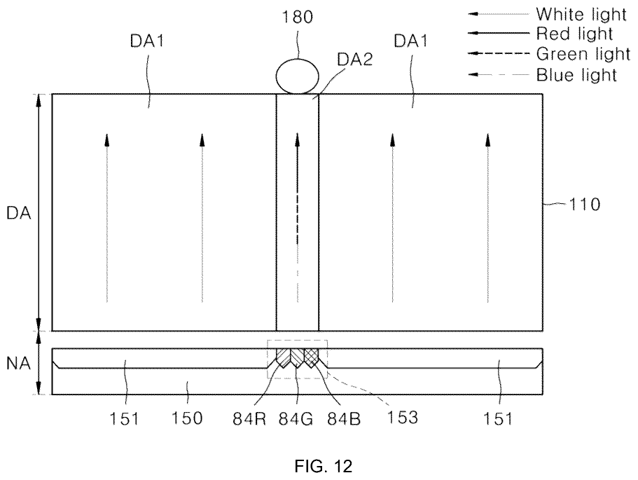

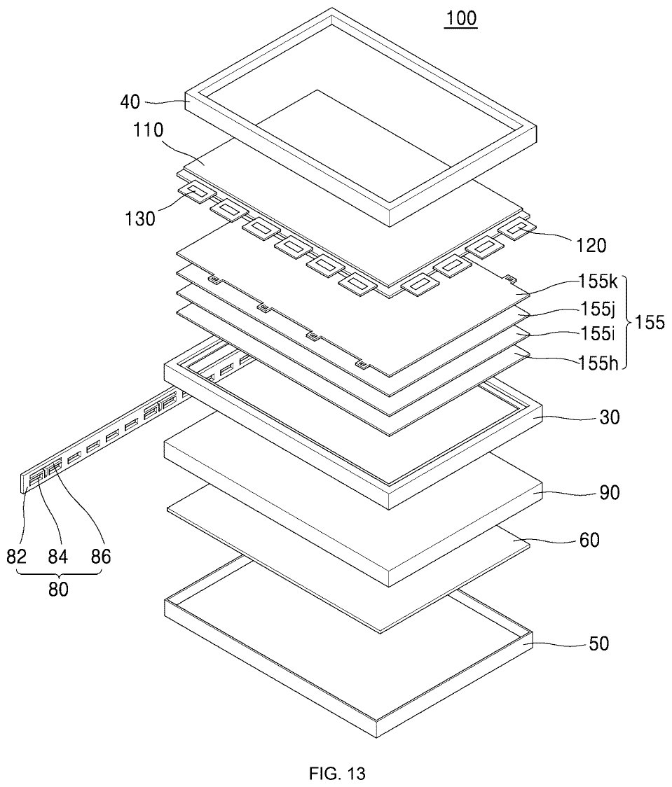

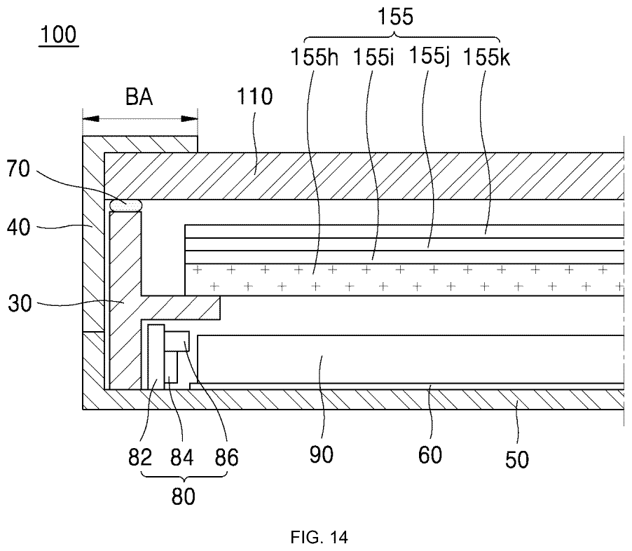

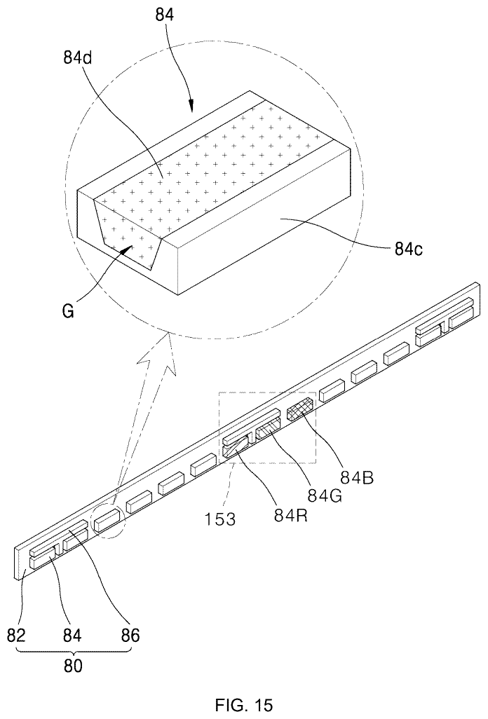

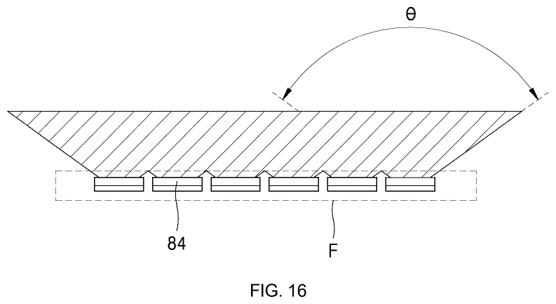

Next, FIG. 12 is a plan view schematically illustrating a display device according to still another implementation of the present disclosure. Also, FIG. 13 is an exploded perspective view illustrating a display device according to still another implementation of the present disclosure, FIG. 14 is a coupled cross-sectional view illustrating a portion of a display device according to still another implementation of the present disclosure, and FIG. 15 is an enlarged perspective view of an LED package module according to still another implementation of the present disclosure. Also, FIG. 16 is a diagram for illustrating a beam angle of an LED package according to still another implementation of the present disclosure.

Referring to FIG. 12, the display device according to still another implementation of the present disclosure can include a liquid crystal panel 110 including a display area DA and a backlight unit 150 disposed in a non-display area NA. The liquid crystal panel 110 can include a first area DA1 and a second area DA2 disposed in a center of the first area DA1. Also, the first area DA1 and the second area DA2 have the same length in the column direction.

In addition, the first area DA1 is a general display area including a light-emitting area, and the second area DA2 is an optical area through which light transmits. The first area DA1 can also be disposed on each of the left side and the right side around the second area DA2. In the display device, the camera sensor unit 180 can be disposed in the non-display area NA. In particular, the camera sensor unit 180 and the second area DA2 can be aligned with each other in a line in the column direction. The camera sensor unit 180 can also include a camera.

Further, the backlight unit 150 can include a first backlight 151 aligned with each of the left and right portions of the first area DA1 in a line in the column direction and a third backlight 153 aligned with the second area DA2 in a line in the column direction. The backlight unit 150 can also include an LED package module in which a plurality of LEDs chips used as light sources are disposed. Accordingly, the backlight unit 150 can be referred to as an LED package module 150.

Like the first backlight 151 as illustrated in FIG. 1, the first backlight 151 can include a plurality of first light sources 151-1 to 151-n that emit light of the same color. For example, the first backlight 151 can include a plurality of white LED chips. The first backlight 151 can include an LED package module in which a plurality of white LED chips are disposed.

In addition, the third backlight 153 can include a plurality of second light sources 152-1 to 152-m that emit light of different colors. For example, the third backlight 153 can include a red LED chip 84R emitting red (R) light, a green LED chip 84G emitting green (G) light, and a blue LED chip 84B emitting blue (B) light. The third backlight 153 can also include an LED package module 80 in which a red LED chip 84R, a green LED chip 84G, and a blue LED chip 84B are disposed.

Further, the camera sensor unit 180 can include a camera. In particular, the camera can be disposed in one side of the non-display area NA and can be aligned with the second area DA2 in a line in a column direction and can be disposed under the liquid crystal panel 110. The light receiving element of the camera can also be oriented in a direction perpendicular to a direction in which the light emitted from the backlight is incident to the light receiving surface of the liquid crystal panel 110.

Referring to FIGS. 13 and 14, in the display device, a light guide plate 90 can be disposed under the lower surface of the liquid crystal panel 110 and in the display area DA. In addition, the LED package module 80 can be disposed in the non-display area NA so as to be spaced apart from a side surface of the light guide plate 90.

Further, the first backlight 151 can include an LED package module including a plurality of LEDs chips arranged and oriented to face the side surface of the light guide plate 90 so that the same white light can be incident through the light guide plate 90 onto the first area DA1 of the liquid crystal panel 110. Also, the third backlight 153 can include an LED package module having a plurality of LEDs chips arranged and oriented to face the side surface of the light guide plate 90 such that light beams of different colors are incident through the light guide plate 90 into the second area DA2 of the liquid crystal panel 110.

In addition, the liquid crystal panel 110 plays a key role in realizing an image. The liquid crystal panel 110, as illustrated in FIGS. 3A, 4, and 5, includes the first substrate 111a and the second substrate 111b that are bonded to each other and are spaced from each other by a predetermined spacing, and the liquid crystal layer 190 interposed between the first and second substrates. Various lines and the pixel electrode 118 together with the thin-film transistor Tr are disposed on the first substrate 111a. The color filter layer 186 for displaying the RGB ternary colors and the black matrix 184 are disposed on the second substrate 111b.

In this instance, the color filter layer 186 can not be disposed above the liquid crystal panel 110 in the second area DA2. The color filter layer 186 can be disposed above the liquid crystal panel 110 in the first area DA1. In addition, the liquid crystal panel 110 further includes the data driver circuit 130 and the gate driver circuit 120 for controlling the operation of the liquid crystal layer 190. As illustrated in FIGS. 1, 3A, 4, and 5, the data driver circuit 130 is connected to the data line DL of the first substrate 111a to supply the data signal to the data line DL, while the gate driver circuit 120 is connected to the gate line GL of the first substrate 111a to supply a scan signal to the gate line GL.

Referring to FIGS. 12 to 14, in the display device, a reflective plate 60 can be disposed on a bottom frame 50, the light guide plate 90 can be disposed thereon, a main frame 30 can be disposed thereon, an optical member 155 can be disposed thereon, the liquid crystal panel 110 can be disposed thereon, and a top frame 40 can be disposed thereon. Also, the main frame 30 is disposed under a lower surface of the liquid crystal panel 110 so as to support an edge of the liquid crystal panel 110. To this end, the main frame 30 can have a rectangular frame shape.

In addition, a plurality of optical members 155 are seated on the main frame 30. In this instance, the plurality of optical members 155 refract or scatter light incident thereto from the LED package module 80 in order to widen the viewing angle of the display device 100 and increase the luminance thereof. Specifically, the plurality of optical members 155 can include at least two of a diffuser sheet 155h, a prism sheet 155i, a protective sheet 155j, and a luminance enhance sheet 155k. In this instance, FIGS. 13 and 14 show an example of a four-layer structure in which the diffuser sheet 155h, the prism sheet 155i, the protective sheet 155j, and the luminance enhancement sheet 155k are sequentially stacked to constitute the plurality of optical members 155.

In addition, the diffuser sheet 155h diffuses the light emitted from the LED package module 80 along the surface thereof so that the color and brightness of the entire screen of the display device 100 are uniformly visible. Further, the prism sheet 155i serves to increase luminance by refracting or condensing the light diffused by the diffuser sheet 155h. Also, the protective sheet 155j serves to protect the diffuser sheet 155h and the prism sheet 155i from external impact or prevent introduction of foreign substances thereto. In addition, the protective sheet 155j is mounted in order to prevent scratches from occurring on the prism sheet 155i.

In addition, the luminance enhancement sheet 155k is mounted for the purpose of improving the luminance. In particular, the luminance enhancement sheet 155k is a kind of a polarizing film and is referred to as a reflective polarizing film. The luminance enhancement sheet 155k transmits a light beam having a polarized direction parallel to a polarization direction of the luminance enhancement sheet 155k among the light beams emitted from the LED package module 80 therethrough, and reflects light having a polarized direction different from the polarization direction of the luminance enhancement sheet 155k among the light beams emitted from the LED package module 80 therefrom, thereby improving the luminance.

In addition, the bottom frame 50 is mounted on a lower surface of the main frame 30. Four edges of the bottom frame 50 can be bent upwardly to have four side surfaces. Accordingly, the side surfaces of the bottom frame 50 can be in contact with four side surfaces of the main frame 30, respectively.

Referring to FIGS. 13 and 14, in the display device, the reflective plate 60 can be disposed on the bottom frame 50, the light guide plate 90 can be disposed on the reflective plate 60, and the LED package module 80 can be disposed on a side wall surface of the bottom frame 5 so as to be spaced apart from the light guide plate 90. Further, the LED package module 80 includes an LED module substrate 82, and a plurality of LED packages 84 mounted on the LED module substrate 82. Each of the plurality of LED package 84 has a long side and a short side perpendicular to the long side.

In addition, the reflective plate 60 is positioned on a rear surface of the light guide plate 90 and reflects the light passing through the rear surface of the light guide plate 90 therefrom toward the liquid crystal panel 110, thereby improving the luminance of the light. Also, the light guide plate 90 allows light incident thereto from the plurality of LED packages 84 to travel in the light guide plate 90 under total reflection to be evenly spread across a wide area of the light guide plate 90, thereby providing a surface light source to the liquid crystal panel 110.

The light guide plate 90 can include a pattern having a specific shape on the rear surface thereof to supply the uniform surface light source. In this instance, the pattern having the specific shape can be designed in various forms, such as an elliptical pattern, a polygonal pattern, and a hologram pattern, in order to guide light incident into the light guide plate 90. The pattern having the specific shape can be formed on the rear surface of the light guide plate 90 in a printing manner or an injection manner.

In this regard, it is illustrated that the LED package module 80 is mounted on one short side of the main frame 30. However, implementations of the present disclosure are not limited thereto. That is, the LED package module 80 can be mounted on each of both opposing short sides of the main frame 30. In addition, the LED package module 80 can be mounted only on one long side of the main frame 30 or can be mounted only on each of both opposing long sides of the main frame 30.

In addition, the liquid crystal panel 110 is attached to the main frame 30 via an adhesive member 70 disposed between the main frame 30 and the liquid crystal panel. Also, the LED package module 80 is mounted on at least one side edge of the bottom frame 50. Accordingly, the LED package module 80 is disposed on the side wall surface of the bottom frame 50 and is spaced apart from the light guide plate 90 by a predetermined spacing. The LED package module 80 includes an LED module substrate 82, a plurality of LED packages 84, and a shock-absorbing pad 86.

Referring to FIG. 15, each of the plurality of LED packages 84 mounted on the LED module substrate 82 has an open surface G formed so as to be exposed by cutting a portion of each of both opposing short sides by mold dicing. Accordingly, each of the plurality of LED packages 84 have a structure in which light is emitted in an upward direction and in both lateral directions through the both opposing open surfaces G. Thus, an emission angle of the light beam emitted from each of the plurality of LED packages 84 is increased, and thus, for example, each of the plurality of LED packages 84 has the beam angle θ in a range of 125° to 150°.

At least one shock-absorbing pad 86 is mounted in a space between adjacent ones of the plurality of LED packages 84 to prevent adjacent ones of the plurality of LED packages 84 from being in close contact with the light guide plate 90. In this instance, the shock-absorbing pad 86 can be designed in a T-shape, and for this reason, can be used as a T-pad.

Further, in the display device 100 according to another implementation of the present disclosure, the plurality of LED packages 84 are in close contact with the light guide plate 90 as much as possible to implement a narrow bezel. In this instance, damage to the plurality of LED packages 84 can be caused when the light guide plate 90 moves due to external impact or thermal expansion. Thus, the shock-absorbing pad 86 is designed to prevent this situation in advance. Therefore, it is preferable that a thickness of the shock-absorbing pad 86 be designed to be larger than a thickness of each of the plurality of LED packages 84 in the cross-sectional view.

Referring to FIG. 15, each of the plurality of LED packages 84 can include at least one LED chip mounted on the LED module substrate 82, a mold frame 84c supporting the LED chip, and an encapsulant 84d sealing a substrate and the LED chip mounted in the mold frame. Also, the mold frame 84c can have a structure in which both opposing short side surfaces thereof are open. Further, the encapsulant 84d can have the open surface G exposed to the outside due to the mold frame having a structure in which both short side surfaces are open.

Referring to FIG. 16, the LED package 84 has the beam angle θ in which light is emitted in an upward direction and in both lateral directions through the both open surfaces G. Accordingly, each of the plurality of LED packages 84 has, for example, the beam along in a range of 125° to 150°, such that an overlapping area of the light beams respectively emitted from the adjacent LED packages 84 can be considerably closer to each of the plurality of LED packages 84 compared to a conventional structure. Thus, a shielding area F of the light incident portions of the plurality of LED packages 84 can be reduced, thereby making it possible to implement a narrow bezel.

In this regard, based on a 55 inches screen, a conventional display device designs the bezel area BA to be approximately 5.9 mm due to the LED package having the narrow beam angle. However, in the display device 100 according to another implementation of the present disclosure, the bezel area BA can be designed to be approximately 3.9 mm by introducing the LED package 84 having the wide beam angle.

In this instance, the shock-absorbing pad 86 can be made of a material having a pure white color, or can be made of a material having a milky color having an optimal condition for absorption and reflection, thereby reducing a hot spot defect at a light incident portion. For example, the shock-absorbing pad 86 can include 95 to 99 wt % of a base resin and 1 to 5 wt % of milky pigments added thereto. Accordingly, the shock-absorbing pad 86 has transparency of 50 to 90%.

When the amount of the milky pigments is smaller than 1 wt % of a total weight of the shock-absorbing pad 86, the amount of the milky pigments is insignificant, and thus it can be difficult to properly exert the above effect. On the contrary, when the amount of the milky pigments is greater than 5 wt % of the total weight of the shock-absorbing pad 86, this can act as a factor that degrades the luminous efficiency of light emitted from the LED package 84 due to excessive light absorption.

In this instance, the base resin can include one or more selected from polycarbonate (PC), polyimide resin (PI), polyethylene terephthalate (PET), polyethylene sulfone (PES), etc. In addition, silsesquioxane can be used as a material of the milky pigments. However, implementations of the present disclosure are not limited thereto.

In the display device 100 according to another implementation of the present disclosure described above, the shock-absorbing pad 86 has the milky material having the optimal condition for absorption and reflection and the LED package 84 has the beam angle θ in a range of 125° to 150°, such that the implementation of the narrow bezel can be achieved while the hot spot defect in the light incident portion due to the implementation of the narrow bezel can be reduced.

Referring to FIGS. 12 to 16, the backlight unit 150 can include a first backlight 151 corresponding to the first area DA1 and a third backlight 153 corresponding to the second area DA2. Each of the first backlight 151 and the third backlight 153 can include a plurality of LEDs packages. In addition, the first backlight 151 can include a plurality of first LED packages mounted such that the open surface G thereof faces the side surface of the light guide plate 90 among the plurality of LEDs packages. The plurality of first LED packages can include a plurality of white LED chips W.

Further, the third backlight 153 can include a plurality of second LED packages mounted such that the open surface G faces the side surface of the light guide plate 90 among the plurality of LED packages. Also, plurality of second LED packages can include a plurality of red LED chips R, a plurality of green LED chips G, and a plurality of blue LED chips B.

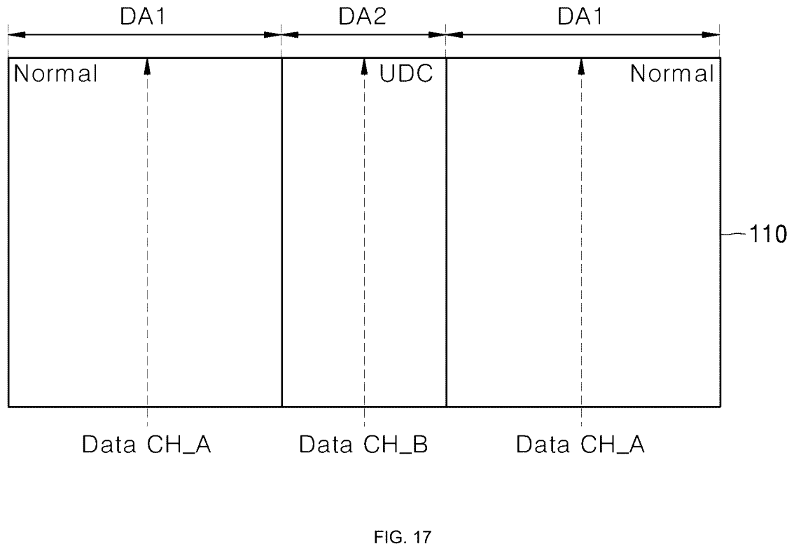

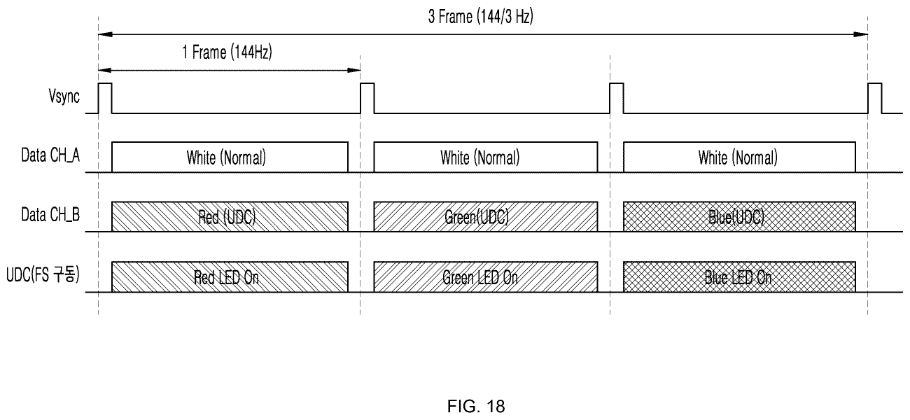

Next, FIG. 17 is a plan view illustrating an operation of a display panel in each area and FIG. 18 is a timing diagram for illustrating a driving scheme on each area of a display panel according to still another implementation of the present disclosure.

Referring to FIG. 17, the data driver circuit 130 can apply a first data signal Data CH_A to the first area DA1 of the liquid crystal panel 110 and can apply a second data signal Data CH_B to the second area DA2. In particular, the data driver circuit 130 applies the data signal (e.g., a data voltage) on a frame basis of input image data. The data driver circuit 130 also respectively applies the data signals to the data line DLa disposed in the first area DA1 and the data line DLb disposed in the second area DA2 based on different driving frequencies.

Further, the driving frequency can include, for example, a specific frequency in a range of 144 Hz to 240 Hz. When an operation period of the display panel is divided into three frames, a specific frequency in a range of 48 Hz to 80 Hz can be user for each frame. In this regard, the backlight driver circuit 160 drives the first backlight 151 and the third backlight 153 based on different driving frequencies. In addition, the backlight driver circuit 160 can be synchronized with the data driver circuit 130 to control the operation of each of the first backlight 151 and the third backlight 153 on a frame basis.

In more detail, in FIG. 18, an example in which a full white image is displayed in the display area DA of the liquid crystal panel 110 in a state in which the camera 170 is turned off will be described. When the vertical synchronization signal Vsync is input, the data driver circuit 130 applies a data signal Data CH_A to a White (Normal) pixel for outputting a full white image via the data line DLa disposed only in the first area DA1 for a first fame. In this regard, the data driver circuit 130 applies a data signal Data CH_A to a White (Normal) pixel for outputting a full white image via the data line DLa disposed only in the first area DA1 for each of subsequent frames in the same manner. However, the data driver circuit 130 separately applies the data signal to the first area DA1 and the data signal to the second area DA2.

Referring to FIG. 18, the data signal Data CH_A is applied to the normal (White) pixel in the first area DA1 for a substantial entire period of each frame. In this instance, when the vertical synchronization signal Vsync is input, the backlight driver circuit 160 can turn on all white (W) LEDs of the first backlight 151 disposed in the first area DA1 for each frame.

Meanwhile, when the vertical synchronization signal Vsync is input, the data driver circuit 130 sequentially applies the data signals Data CH_B to the Red (UDC) pixel, Green (UDC) pixel, and Blue (UDC) pixel for outputting a full white image disposed in the second area DA2 via the data line DLb disposed in the second area DA2 for consecutive frames. That is, the data driver circuit 130 sequentially applies the data signals to the Red (UDC) pixel, the Green (UDC) pixel, and the Blue (UDC) pixel one by one for the consecutive frames.

In addition, for the first frame Frame 1, when the vertical synchronization signal Vsync is input, the backlight driver circuit 160 can turn on the red LED chip 84R of the third backlight 153 corresponding to the second area DA2 (Red LED On). Accordingly, red (R) light from the red LED chip 84R of the third backlight 153 can be applied to the second area DA2 for the first frame Frame 1.

In addition, for the second frame Frame 2, when the vertical synchronization signal Vsync is input, the backlight driver circuit 160 can turn on the green LED chip 84G of the third backlight 153 corresponding to and overlapping the second area DA2 (Green LED On). Accordingly, green (G) light from the green LED chip 84G of the third backlight 153 can be applied to the second area DA2 for the second frame Frame2.

Further, for the third frame Frame 3, when the vertical synchronization signal Vsync is input, the backlight driver circuit 160 can turn on the blue LED chip 84B of the third backlight 153 corresponding to and overlapping the second area DA2 (Blue LED On). Accordingly, blue (B) light from the blue LED chip 84B of the third backlight 153 can be applied to the second area DA2 for the third frame Frame 3.

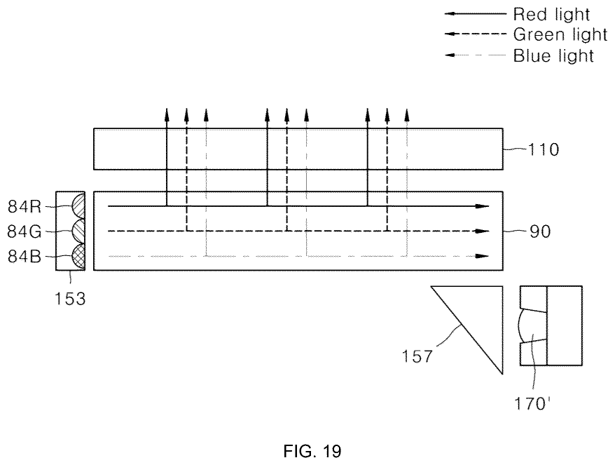

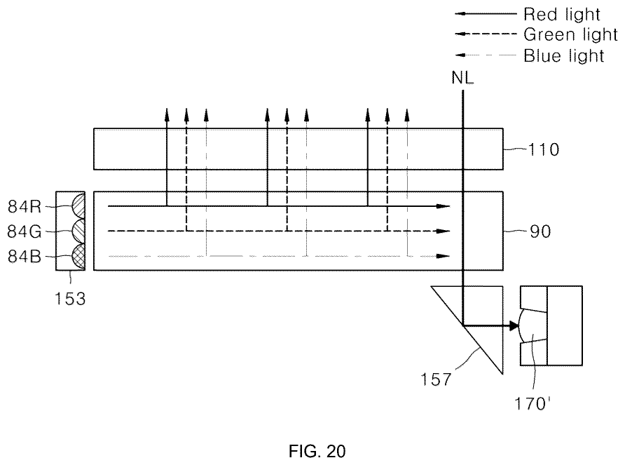

Next, FIG. 19 is a diagram for illustrating a backlight operation in a camera OFF state of a display device and FIG. 20 is a diagram for illustrating a backlight operation in a camera ON state of a display device according to still another implementation of the present disclosure.

Referring to FIGS. 19 and 20, in the display device according to still another implementation of the present disclosure, the liquid crystal panel 110 can be positioned on top of the light guide plate 90. Further, the third backlight 153 is spaced apart, by a predetermined spacing, from the side surface of the light guide plate 90. The optical prism 157 is disposed under the right side portion of the lower surface of the light guide plate 90.

In addition, the optical prism 157 can have a reflective surface that reflects light input from the liquid crystal panel 110. Also, the angle of the reflection surface of the optical prism 157 can be, for example, 45 degrees with respect to the light incident direction from the light guide plate to the liquid crystal panel 110.

Further, the camera 170′ can be disposed at a path along which light reflected from the reflective surface of the optical prism 157 travels. Accordingly, the light receiving element of the camera 170′ can be oriented in a perpendicular direction to a direction in in which the light from the light guide plate is incident to the light receiving surface of the liquid crystal panel 110. In addition, the third backlight 153 can include the red LED chip 84R, the green LED chip 84G, and the blue LED chip 84B.

Referring to FIG. 19, when the camera 170′ is in the OFF state, the third backlight 153 can turn on each of the red LED chip 84R, the green LED chip 84G, and the blue LED chip 84B to emit each of red (R) light, green (G) light, or blue (B) light. The red LED chip 84R, the green LED chip 84G, and the blue LED chip 84B of the third backlight 153 can respectively emit red (R) light, green (G) light, and blue (B) light to the light guide plate 90. Then, the red (R) light, green (G) light, and blue (B) light incident to the light guide plate 90 can be refracted by the light guide plate 90 so as to travel upwardly and then be applied to the liquid crystal panel 110.

Referring to FIG. 20, when the red LED chip 84R, the green LED chip 84G, and the blue LED chip 84B of the third backlight 153 emit light, the camera 170′ is turned on. In this instance, nature light NL is input from the outside out of the liquid crystal panel 110 to the liquid crystal panel 110 and then is incident on the optical prism 157.

The reflective surface of the optical prism 157 reflects the natural light NL input from the liquid crystal panel 110 toward the camera 170′. Accordingly, the camera 170′ can acquire an image using the natural light incident from the optical prism 157.

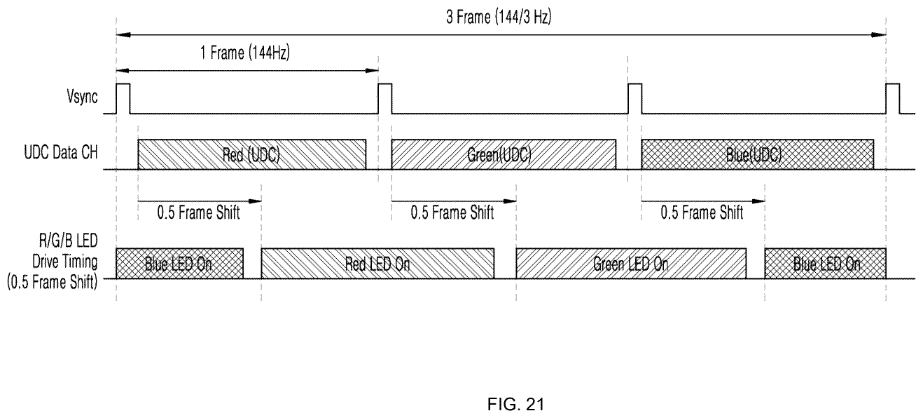

Next, FIG. 21 is a timing diagram for illustrating a backlight operation in a camera ON state of a display device according to another implementation of the present disclosure. Referring to FIG. 21, the backlight driver circuit 160 can apply a shift time (0.5 Frame Shift) obtained by shifting the time by a predetermined period (e.g., 0.5 frame) from a point at which the data signal UDC Data CH is applied to each of the red LED chip 84R, the green LED chip 84G, and the blue LED chip 84B of the third backlight 153 for each frame, in consideration of the liquid crystal response characteristics of the liquid crystal layer 190 of the liquid crystal panel 110.

Referring to FIG. 21, in response to that the shift time (0.5 Frame Shift) has elapsed after the data signal Red (UDC) starts to be applied to the R (red) pixel in the second area DA2 for the first frame Frame 1, the backlight driver circuit 160 can output a driving signal Red LED On for turning on the red LED chip 84R. Subsequently, the backlight driver circuit 160 can respectively and sequentially output the driving signals Green LED On and Blue LED On to the green LED chip 84G and the blue LED chip 84B in the same manner as the application of the driving signal Red LED On.

For example, in response to that the shift time (0.5 Frame Shift) has elapsed after the data signal Green (UDC) starts to be applied to the G (green) pixel in the second area DA2 for the second frame Frame 2, the backlight driver circuit 160 can output the driving signal Green LED On for turning on the green LED chip 84G. Subsequently, in response to that the shift time (0.5 Frame Shift) has elapsed after the data signal Blue (UDC) starts to be applied to the B (blue) pixel in the second area DA2 for the third frame Frame 3, the backlight driver circuit 160 can output the driving signal Blue LED On for turning on the blue LED chip 84B.

A first aspect of the present disclosure provides a display device including a liquid crystal panel including a display area including a first area and a second area at least partially surrounded with the first area, and a non-display area surrounding the display area; a first backlight disposed under the liquid crystal panel and in the first area; a second backlight disposed under the liquid crystal panel and in the second area; and a camera disposed under the liquid crystal panel and adjacent to the second backlight, wherein the second area includes: a light-transmissive area vertically overlapping the camera, wherein a light source is not disposed under the liquid crystal panel in the light-transmissive area; a peripheral area surrounding the light-transmissive area, wherein the second backlight is disposed under the liquid crystal panel in the peripheral area; and a color filter disposed above the liquid crystal panel in the first area and excluded above the liquid crystal panel in the second area.

In addition, the first backlight includes a plurality of first light sources facing and vertically overlapping the liquid crystal panel and configured to emit light of a same color, wherein the second backlight includes a plurality of second light sources facing and vertically overlapping the liquid crystal panel and configured to emit light of different colors, respectively. Also, the first light source and the second light source are configured to emit light of different colors, wherein the first light source includes a plurality of white LEDs, wherein the second light source includes a plurality of red LEDs, a plurality of green LEDs, and a plurality of blue LEDs.

Further, the camera is disposed to vertically overlap the light-transmissive area of the second area, wherein a light receiving element of the camera faces the liquid crystal panel. Also, the display device further comprises an optical prism disposed under the liquid crystal panel and disposed above the second backlight in the second area, wherein the camera is disposed in the non-display area and perpendicular to a light incident surface of the liquid crystal panel, wherein a light receiving element of the camera faces the light incident surface in a second direction perpendicular to a first direction which light from the second backlight is emitted to the liquid crystal panel

In addition, the camera is disposed in a side portion of the non-display area. The liquid crystal panel includes a plurality of gate lines extending along a first direction in the display area; a plurality of data lines extending along a second direction intersecting the first direction in the display area; a backlight driver circuit configured to independently drive the first backlight and the second backlight; and a plurality of pixels respectively disposed in intersection areas between the plurality of gate lines and the plurality of data lines, wherein the plurality of data lines includes: a plurality of first data lines disposed in the first area; and a plurality of second data lines disposed both in the first area and the second area, wherein the display device further comprises a data driver circuit configured to apply data signals of different driving frequencies to the plurality of first data lines and the plurality of second data lines, respectively.

Further, in response to that the camera is turned off, the data driver circuit is configured to: for a first period of a first frame among a plurality of consecutive frames, apply a data signal to a plurality of pixels displaying a first color disposed in the second area through the plurality of second data lines; for a first period of a second frame among the plurality of consecutive frames, apply a data signal to a plurality of pixels displaying a second color disposed in the second area through the plurality of second data lines; and for a first period of a third frame among the plurality of consecutive frames, apply a data signal to a plurality of pixels displaying a third color disposed in the second area through the plurality of second data lines.

Also, the data driver circuit is configured to: for a second period subsequent to the first period of each of the first to third frames, simultaneously apply data signals to a plurality of pixels respectively displaying the first to third colors disposed in the first area through the plurality of second data lines. In addition, the data driver circuit is further configured to apply data signals to the plurality of pixels respectively displaying the first to third colors through the plurality of first data lines for each of the plurality of frames.

In addition, the backlight driver circuit is further configured to turn off all of the plurality of second light sources when the camera is turned on. Also, the data driver circuit is further configured to: apply data signals for outputting a black image to the plurality of pixels displaying the first color, the plurality of pixels displaying the second color, and the plurality of pixels displaying the third color disposed in the peripheral area of the second area through the plurality of second data lines; and apply data signals for outputting a white image to the plurality of pixels displaying the first color, the plurality of pixels displaying the second color, and the plurality of pixels displaying the third color disposed in the light-transmissive area of the second area through the plurality of second data lines.

Further, in response to that the camera is turned off, the backlight driver circuit is further configured to for the first frame, turn on the second light source corresponding to the first color of the second backlight, and turn off the second light source corresponding to each of the second and third colors; for the second frame, turn on the second light source corresponding to the second color of the second backlight, and turn off the second light source corresponding to each of the first and third colors; and for the third frame, turn on the second light source corresponding to the third color of the second backlight, and turn off the second light source corresponding to each of the first and second colors.

A second aspect of the present disclosure provides a display device including a liquid crystal panel including a display area and a non-display area, wherein the display area includes a first area and a second area having a same length in a column direction in a plan view of the display device, wherein the first area include two portions respectively disposed on both opposing sides in a row direction of the second area; a camera disposed under the liquid crystal panel and in one of both opposing sides in the column of the non-display area in the plan view, wherein the camera and the second area are aligned with each other in a line in the column direction; a light guide plate disposed under the liquid crystal panel in the display area; and an LED package module spaced apart from a side surface of the light guide plate and disposed under the liquid crystal panel in the non-display area, wherein a light receiving element of the camera is positioned perpendicular the light incident surface of the liquid crystal panel, wherein the LED package module includes a first backlight facing the side surface of the light guide plate, and configured to emit light of the same color to the light guide plate such that the light of the same color is incident from the light guide plate onto the first area; and a second backlight oriented to face the side surface of the light guide plate and configured to emit light of different colors to the light guide plate such that the light of different colors are incident from the light guide plate onto the second area, wherein a color filter is not disposed above of the liquid crystal panel and in the second area, and the color filter is disposed above of the liquid crystal panel in the first area.

In addition, an LED package module includes: a LED module substrate; and a plurality of LED packages mounted on the LED module substrate, wherein each of the plurality of LED packages has both opposing short sides and both opposing long sides in a plan view of each of the plurality of LED packages. Also, each of the plurality of LED packages comprises: at least one LED chip mounted on the LED module substrate; a mold frame supporting the LED chip, wherein both opposing side surfaces of the mold frame are open based on the short sides; and an encapsulant sealing the substrate and the LED chip in the mold frame, wherein the encapsulant has an open surface exposed to an outside via the mold frame.

In addition, the first backlight includes a plurality of first LED packages among the plurality of LEDs packages, wherein each of the plurality of first LED packages is mounted such that the open surface thereof faces the side surface of the light guide plate, the second backlight includes a plurality of second LED packages among the plurality of LEDs packages, and each of the plurality of second LED packages is mounted such that the open surface thereof faces the side surface of the light guide plate.

Further, the plurality of first LED packages include a plurality of white LED chips, wherein the plurality of second LED packages include a plurality of red LED chips, a plurality of green LED chips, and a plurality of blue LED chips.

A third aspect of the present disclosure provides a display device including: a liquid crystal panel including a display area and a non-display area surrounding the display area; a camera disposed under the liquid crystal panel and configured to capture images through the liquid crystal panel; first and second backlights disposed under the liquid crystal panel excluding at a position corresponding to the camera, wherein the second backlight is disposed adjacent to the camera, and the first backlight is disposed adjacent to the second backlight; and a color filter disposed above the liquid crystal panel in an area excluding a position of the camera, wherein when the camera is turned on, the first backlight emits a white light and the second backlight is turned off, and when the camera is turned off, the first backlight emits a white light and the second backlight emits red, green and blue light.

Further, when the camera is turned off, the second backlight emits a red light in a first frame, emits a green light in a second frame and emits a blue light in a third frame, and the first backlight emits the white light in the first, second and third frames.

Although some implementations of the present disclosure have been described above with reference to the accompanying drawings, the present disclosure may not be limited to some implementations and can be implemented in various different forms. Those of ordinary skill in the technical field to which the present disclosure belongs will be able to appreciate that the present disclosure can be implemented in other specific forms without changing the technical idea or essential features of the present disclosure. Therefore, it should be understood that some implementations as described above are not restrictive but illustrative in all respects.

What is claimed is:

1. A display device comprising:
a liquid crystal panel including a display area including a first area and a second area at least partially surrounded with the first area, and a non-display area surrounding the display area;
a first backlight disposed under the liquid crystal panel and in the first area;
a second backlight disposed under the liquid crystal panel and in the second area; and
a camera disposed under the liquid crystal panel and adjacent to the second backlight,
wherein the second area includes:
a light-transmissive area vertically overlapping the camera, wherein a light source is not disposed under the liquid crystal panel in the light-transmissive area;
a peripheral area surrounding the light-transmissive area, wherein the second backlight is disposed under the liquid crystal panel in the peripheral area; and
a color filter disposed above the liquid crystal panel in the first area and excluded above the liquid crystal panel in the second area.

2. The display device of claim 1, wherein the first backlight includes a plurality of first light sources facing and vertically overlapping the liquid crystal panel and configured to emit light of a same color, and
wherein the second backlight includes a plurality of second light sources facing and vertically overlapping the liquid crystal panel and configured to emit light of different colors, respectively.

3. The display device of claim 2, wherein the first light source includes a plurality of white LEDs, and
wherein the second light source includes a plurality of red LEDs, a plurality of green LEDs, and a plurality of blue LEDs.

4. The display device of claim 1, wherein the camera vertically overlaps the light-transmissive area of the second area, and
wherein a light receiving element of the camera faces the liquid crystal panel.

5. The display device of claim 1, further comprising:
an optical prism disposed under the liquid crystal panel and above the second backlight in the second area,
wherein the camera is disposed in the non-display area and perpendicular to a light incident surface of the liquid crystal panel, and
wherein a light receiving element of the camera faces the light incident surface in a second direction perpendicular to a first direction which light from the second backlight is emitted to the liquid crystal panel.

6. The display device of claim 1, wherein the camera is disposed in a side portion of the non-display area.

7. The display device of claim 2, wherein the liquid crystal panel includes:
a plurality of gate lines extending along a first direction in the display area;
a plurality of data lines extending along a second direction intersecting the first direction in the display area;
a backlight driver circuit configured to independently drive the first backlight and the second backlight; and
a plurality of pixels respectively disposed in intersection areas between the plurality of gate lines and the plurality of data lines,
wherein the plurality of data lines includes:
a plurality of first data lines disposed in the first area; and
a plurality of second data lines disposed both in the first area and the second area, and
wherein the display device further comprises a data driver circuit configured to apply data signals of different driving frequencies to the plurality of first data lines and the plurality of second data lines, respectively.

8. The display device of claim 7, wherein in response to the camera being turned off, the data driver circuit is configured to:
for a first period of a first frame among a plurality of consecutive frames, apply a data signal to a plurality of pixels displaying a first color disposed in the second area through the plurality of second data lines;
for a first period of a second frame among the plurality of consecutive frames, apply a data signal to a plurality of pixels displaying a second color disposed in the second area through the plurality of second data lines; and
for a first period of a third frame among the plurality of consecutive frames, apply a data signal to a plurality of pixels displaying a third color disposed in the second area through the plurality of second data lines.

9. The display device of claim 8, wherein the data driver circuit is further configured to:
for a second period subsequent to the first period of each of the first to third frames, simultaneously apply data signals to the plurality of pixels respectively displaying the first to third colors disposed in the first area through the plurality of second data lines.

10. The display device of claim 8, wherein the data driver circuit is further configured to apply data signals to the plurality of pixels respectively displaying the first to third colors through the plurality of first data lines for each of the plurality of frames.

11. The display device of claim 7, wherein the backlight driver circuit is further configured to turn off all of the plurality of second light sources when the camera is turned on.

12. The display device of claim 11, wherein the data driver circuit is further configured to:
apply data signals for outputting a black image to the plurality of pixels displaying the first color, the plurality of pixels displaying the second color, and the plurality of pixels displaying the third color disposed in the peripheral area of the second area through the plurality of second data lines; and
apply data signals for outputting a white image to the plurality of pixels displaying the first color, the plurality of pixels displaying the second color, and the plurality of pixels displaying the third color disposed in the light-transmissive area of the second area through the plurality of second data lines.

13. The display device of claim 7, wherein in response to the camera being turned off, the backlight driver circuit is further configured to:
for the first frame, turn on the second light source corresponding to the first color of the second backlight, and turn off the second light source corresponding to each of the second and third colors;
for the second frame, turn on the second light source corresponding to the second color of the second backlight, and turn off the second light source corresponding to each of the first and third colors; and
for the third frame, turn on the second light source corresponding to the third color of the second backlight, and turn off the second light source corresponding to each of the first and second colors.

14. A display device comprising:
a liquid crystal panel including a display area and a non-display area, wherein the display area includes a first area and a second area having a same length in a column direction in a plan view of the display device, and wherein the first area include two portions respectively disposed on both opposing sides in a row direction of the second area;
a camera disposed under the liquid crystal panel and in one of both opposing sides in the column of the non-display area in the plan view, wherein the camera and the second area are aligned with each other in a line in the column direction;
a light guide plate disposed under the liquid crystal panel in the display area; and
an LED package module spaced apart from a side surface of the light guide plate and disposed under the liquid crystal panel in the non-display area,
wherein a light receiving element of the camera is positioned perpendicular the light incident surface of the liquid crystal panel,
wherein the LED package module includes:
a first backlight facing the side surface of the light guide plate, and configured to emit light of a same color to the light guide plate such that the light of the same color is incident from the light guide plate onto the first area; and
a second backlight facing the side surface of the light guide plate and configured to emit light of different colors to the light guide plate such that the light of different colors are incident from the light guide plate onto the second area, and
wherein a color filter is not disposed above the liquid crystal panel in the second area, and the color filter is disposed above the liquid crystal panel in the first area.

15. The display device of claim 14, wherein the LED package module comprises:
an LED module substrate; and
a plurality of LED packages mounted on the LED module substrate, and
wherein each of the plurality of LED packages has both opposing short sides and both opposing long sides in a plan view of each of the plurality of LED packages.

16. The display device of claim 15, wherein each of the plurality of LED packages comprises:
at least one LED chip mounted on the LED module substrate;
a mold frame supporting the LED chip, wherein both opposing side surfaces of the mold frame are open based on the short sides; and
an encapsulant sealing the substrate and the LED chip in the mold frame, wherein the encapsulant has an open surface exposed to an outside via the mold frame.

17. The display device of claim 16, wherein the first backlight includes a plurality of first LED packages among the plurality of LEDs packages,
wherein each of the plurality of first LED packages is mounted such that the open surface thereof faces the side surface of the light guide plate,
wherein the second backlight includes a plurality of second LED packages among the plurality of LEDs packages, and
wherein each of the plurality of second LED packages is mounted such that the open surface thereof faces the side surface of the light guide plate.

18. The display device of claim 17, wherein the plurality of first LED packages include a plurality of white LED chips, and
wherein the plurality of second LED packages include a plurality of red LED chips, a plurality of green LED chips, and a plurality of blue LED chips.

19. A display device comprising:
a liquid crystal panel including a display area and a non-display area surrounding the display area;
a camera disposed under the liquid crystal panel and configured to capture images through the liquid crystal panel;
first and second backlights disposed under the liquid crystal panel excluding at a position corresponding to the camera, wherein the second backlight is disposed adjacent to the camera, and the first backlight is disposed adjacent to the second backlight; and
a color filter disposed above the liquid crystal panel an area excluding a position of the camera,
wherein when the camera is turned on, the first backlight emits a white light and the second backlight is turned off, and when the camera is turned off, the first backlight emits a white light and the second backlight emits red, green and blue light.

20. The display device of claim 19, wherein when the camera is turned off, the second backlight emits a red light in a first frame, emits a green light in a second frame and emits a blue light in a third frame, and the first backlight emits the white light in the first, second and third frames.
